(19) United States
(12) Patent Application Publication
(10) Pub. No.: US 2008/0059777 A1
(43) Pub. Date: Mar. 6, 2008

(54) Semiconductor integrated circuit device and compiler device

(76) Inventors: Jiro Miyake, Osaka (JP); Ryoji Kusunoki, Osaka (JP); Toru Morikawa, Osaka (JP); Hiroyuki Mizohata, Osaka (JP); Yasunori Shimizu, Osaka (JP)

Correspondence Address: MCDERMOTT WILL & EMERY LLP, 600 13TH STREET, NW, WASHINGTON, DC, 20005-3096, US

(21) Appl. No.: 11/896,131

(22) Filed: Aug. 29, 2007

(30) Foreign Application Priority Data
Aug. 29, 2006 (JP) 2006-232365

(51) Int. Cl. G06F 9/44; G06F 9/46

(52) U.S. Cl. 712/226; 712/220; 712/E09.032; 712/E09.038

(57) ABSTRACT

An execution program holder holds an execution program that includes execution instructions and configuration instructions that are executed together by a processor. A reconfigurable processing device comprises a programmable device that can reconfigure a circuit, and executes process contents that are instructed through executing the execution instructions by the processor. A circuit information holding and configuration controller holds circuit information that is designated when the processor executes the configuration instructions, and incorporates the reconfigurable processing device with that circuit information to configure a circuit.

### BACKGROUND OF THE INVENTION

1. Field of the Invention

The present invention relates to a compiler device and semiconductor integrated circuit device that are provided with both a processor and programmable device in a mixed loading state, and more particularly to a technique for improving the processing performance of the semiconductor integrated device.

2. Description of the Related Art

Currently, programmable devices such as a PLD (programmable Logic Device) or FPGA (Field Programmable Gate Array) (hereafter, these devices will be referred to as FPGA representatively) are widely used. A FPGA is a device whose circuitry can be designed by the user, and it has the advantage that the circuitry designed by the user can be readily configured immediately so as to realize the operation. Also, since there are advantages that a circuit can be configured repeatedly in a FPGA, it can be flexibly changed to a circuit required in each of cases. Therefore, the problem can be immediately repaired, and the repaired circuit can be used once again as the FPGA when there is a problem in a circuit constituting a FPGA. Moreover, there is the advantage that the circuitry can be repaired, and then, the processing capability can be improved by reconfiguring the circuits of the FPGA, when the required processing performance is not satisfied.

Furthermore, recently, semiconductor integrated circuit device, that has a processor and programmable device in a mixed loading state, has been proposed. In this kind of semiconductor integrated circuit device, in addition to changing the conventional processor program, the circuit configuration in the part consisting of the FPGA can be changed, so the circuit device can respond flexibly to system changes.

As an example of a semiconductor integrated circuit, that has a conventional processor and a FPGA in a mixed loading state, is the data processing circuit described below. That processing circuit has such system configuration that the FPGA is connected to the processor, in order to give the processor general versatility, and realizes a system configuration that is capable of executing a program at high speed by executing a series of processes described below:

Verifying a certain part in the program that lowers the execution speed when the processor executes the program during program compilation.

Creating circuit information for a FPGA that is capable of executing the verified portion of the program at high speed.

Configuring the aforementioned circuit information with the FPGA at the time of activating that program.

However, in a semiconductor integrated circuit device that has a conventional processor and a FPGA in a mixed loading state, special circuits for configuring the FPGA must be developed every source program that is executed. Also, in the aforementioned conventional device, reconfiguring the circuitry of the FPGA while executing a program is not assumed. As a result, all of the necessary circuits for the FPGA must be configured beforehand, so the size of the FPGA becomes large.

### SUMMARY OF THE INVENTION

Therefore, it is the object of the present invention to provide a compiler device and semiconductor integrated circuit device where the circuitry of the FPGA is not necessary to be designed every source program, and the size of the FPGA is kept small.

The semiconductor integrated circuit device of the present invention comprises:

A processor;

an execution program holder that holds an execution program including execution instructions and configuration instructions that are executed by the processor;

a reconfigurable processing device (FPGA, etc.) consisting of a programmable device that can reconfigure a circuit, and for executing process contents that are instructed based on implementation of the execution instructions by the processor; and

a circuit information holding and configuration controller that holds circuit information that is instructed when the processor executes the configuration instructions, and incorporates the circuit information into the reconfigurable processing device to configure a circuit (configuration).

The compiler device of the present invention comprises:

a circuit information library that stores a plurality of circuit information concerning each of the process contents incorporated into a reconfigurable processing device (FPGA, etc.) to be configured; and

a compiler that converts a source program to an execution program.

It is preferable that:

the compiler have a function of separating the process contents into those to be executed by the processor and those to be executed by the reconfigurable processing device;

the compiler separates the process contents so that the number of process cycles of the overall execution program becomes small, in consideration of the number of configuration cycles and the number of execution cycles that are necessary for configuring the circuit information of the respective process contents in the execution program; and

the reconfigurable processing device comprises a programmable device that can reconfigure circuits, and execute the process contents that the processor instructs through implementing execution instructions.

Furthermore, the process contents are instructions such as division “div”, multiplication “mulu”, “mul” and the like.

In the construction described above, there is an embodiment that the compiler:
References the circuit information library that stores a plurality of circuit information for each of the process contents in compiling the source program, and separates the process contents into one that is executed by the reconfigurable processing device (FPGA, etc.) and the other that is executed by the processor, so as to reduce the overall number of processing cycles of the program.
Builds the separated process contents into the execution instructions of the reconfigurable processing device, and builds the configuration instructions into the program to generate an execution program.
Extracts circuit information necessary for the execution instructions from the circuit information library and stores it in the circuit information holding and configuration controller.
Makes the circuit information build into the reconfigurable processing device with the circuit information holding and configuration controller when the processor executes the configuration instructions.
Makes the reconfigurable processing device execute the process contents when the execution instructions are executed.

There is an embodiment that the configuration instructions on and after the second time are ignored, when configuration instructions for incorporating and configuring the same circuit information are successively executed.

Additionally, there is also an embodiment that the operation of the processor is stopped and the circuit information needed in the reconfigurable processing device is incorporated and configured, when circuit information that is necessary in implementing the execution instructions is not incorporated or configured.

As described above, according to this invention, since the compiler effectively uses circuit information that is stored in the circuit information library to compile the source program, it is not necessary to develop a circuit to be configured in the reconfigurable processing device (FPGA) every source program as in the case of the prior art. Therefore, since a circuit information library that is prepared beforehand is used effectively, it is not necessary to design special circuits every source program, which can shorten development time and reduce development cost.

Also, since circuit information necessary for implementation of execution instructions is incorporated and configured dynamically in the reconfigurable processing device, it is better to incorporate and configure only circuit information necessary for executing those process contents in the reconfigurable processing device, and it is enough to prepare a small-scale reconfigurable processing device.

Moreover, the separation condition when the compiler separates the process contents into process contents executed with the processor and process contents executed with the reconfigurable processing device is to reduce the number of overall processing cycles of the program by taking into consideration the number of configuration cycles and the number of execution cycles, so the program can be executed at high speed.

There is an embodiment that the circuit information holding and configuration controller in the semiconductor integrated circuit device constructed as described above comprises:

a circuit information list holder that holds the circuit information;

an address list holder that holds address information for the circuit information; and

an incorporating and configuration unit that reads the address information, from the address list holder, that corresponds to the circuit information designated by the processor, uses the read address information to read circuit information from the circuit information list holder, and then incorporates the read circuit information into the reconfigurable processing device to configure a circuit.

Also, there is an embodiment that the circuit information holding and configuration controller in the semiconductor integrated circuit device constructed as described above further comprises a circuit ID information register that holds circuit ID information that identifies the circuit information that has been already incorporated in the reconfigurable processing device to configure a circuit; and

when the processor sends an instruction to incorporate the circuit information corresponding to the circuit ID information into the reconfigurable processing device so as to configure a circuit, the incorporating and configuration unit compares the circuit ID information concerning the instruction with the circuit ID information that is held in the circuit ID information register, and incorporates the circuit information into the reconfigurable processing device to configure a circuit, only when both do not match each other.

Moreover, there is an embodiment that, in case of executing an execution instruction, the processor of the semiconductor integrated circuit device constructed as described above compares the circuit ID information indicated by the execution instruction with the circuit ID information held in the circuit ID information register, and when both match, instructs the reconfigurable processing device so as to execute the process contents indicated by the execution instruction, and when both do not match, instructs so as to incorporate the circuit information, that corresponds to the circuit ID information indicated by the execution instruction, into the reconfigurable processing device to configure a circuit, and then instructs the reconfigurable processing device to execute the process contents indicated by the execution instruction after the circuit information has been incorporated into the reconfigurable processing device to be configured.

Furthermore, there is an embodiment that the circuit information holding and configuration controller in the semiconductor integrated circuit device constructed as described above further comprises

a status register that indicates whether or not the process for incorporating the circuit information corresponding to the circuit ID information held in the circuit ID information register into the reconfigurable processing device is finished, and

in case of executing the execution instruction, the processor reads the value of the status register and determines whether or not the process for incorporating the circuit information corresponding to the circuit ID information held in the circuit ID information register into the reconfigurable processing device is finished, and the processor pauses the operation of sending an instruction for executing the process contents to the reconfigurable processing device, when the processor determines that the incorporating process is not finished, and sends an instruction for executing the process contents to the reconfigurable processing device, when the processor determines that the incorporating process is finished.

There is an embodiment that the compiler in the compiler device constructed as described above has a function of separating the process contents into the ones to be executed by the processor and the ones to be executed by the reconfigurable processing device;

the compiler separates the process contents so that the number of process cycles of the overall execution program becomes small in consideration of the number of configuration cycles and the number of execution cycles that are necessary for configuring the circuit information of the respective process contents in the execution program; and

the reconfigurable processing device consists of a programmable device that can reconfigure a circuit, and executes process contents that are specified when the processor implements an execution instruction.

Moreover, there is an embodiment that the compiler in the compiler device constructed as described above has

a function for replacing process contents that were separated out as process contents executed by the reconfigurable processing device with execution instructions; and

a function for incorporating configuration instructions, that indicate circuit ID information indicated by the execution instructions, into the execution program.

Furthermore, there is an embodiment that the compiler in the compiler device constructed as described above has

a function of extracting circuit information from the circuit information library that is necessary for the reconfigurable processing device to execute the execution instructions, and creating a circuit information list that contains that circuit information; and

a function of creating an address list that contains addresses where the circuit information stored in the circuit information list is stored.

According to these embodiments, even when a branch or interrupt occurs, and the execution instructions are executed in a state of incorporating circuit information, that is different from the circuit information necessary for the execution instructions, into the reconfigurable processing device (FPGA) to be configured, the process contents can be executed by incorporating and configuring beforehand the circuit information that required by the execution instructions.

Also, when a branch or interrupt occurs, and a configuration instruction, that incorporates the same circuit information into the reconfigurable processing device (FPGA) to be configured, is executed, while incorporating and configuring the arbitrary circuit information, the execution instructions can be executed without taking the number of configuration cycles into consideration by ignoring the configuration instructions on and after the second time.

By the way, when the placement addresses of process contents that can be executed by the reconfigurable processing device (FPGA, etc.) are continuous with each other or are coming close to each other, there is a possibility that the process contents will be judged that the processor should execute process contents regardless of the process contents that are executable by the reconfigurable processing device, from the aspect of the number of configuration cycles. In the case like this, the processing performance cannot be improved through executing with the reconfigurable processing device with respect to process contents judged that the processor should execute it.

In this embodiment, the circuit information list holder comprises the circuit information capable of executing a plurality of the process contents.

Here, it is assumed that, with respect to the circuit information that is incorporated into the reconfigurable processing device (FPGA, etc.) to configure a circuit, at least a part of it comprises a plurality of process contents as executable process contents.

Also, the reconfigurable processing device that is configured with the circuit information held in the execution program holder can execute a plurality of the process contents;

the execution instructions in the execution program holder include circuit selection information that designating any of the plurality of process contents of the circuit information; and

the processor has a function of instructing the reconfigurable processing device to execute the process contents indicated by the circuit selection information.

In the compiler device that corresponds to this, the circuit information library comprises a plurality of the circuit information that can execute a plurality of the process contents.

Moreover, there is an embodiment that the compiler has a function that, by taking into consideration the number of execution cycles, the number of configuration cycles necessary for configuring the reconfigurable processing device with the circuit information, and the process contents that can be executed by the circuit information, separates the process contents in the execution program into process contents executed by the processor and process contents executed by the reconfigurable processing device, so that the number of processing cycles of the overall execution program becomes smaller.

In compiling the source program, the compiler device and semiconductor integrated circuit in these embodiments refer to a circuit information library that stores the circuit information that can execute a plurality of the process contents, and separate the process contents into process contents to be executed by a reconfigurable processing device (FPGA), and process contents to be executed by a processor. At that time, the executable process contents are separated through considering based on the number of configuration cycles, the number of execution cycles and the circuit information, so that the number of processing cycles of the overall program becomes smaller. Furthermore, the compiler incorporates execution instructions and configuration instructions into the program to generate an execution program. The compiler extracts circuit information that is necessary for the execution instructions from a circuit information library, and stores it in a circuit information holding and configuration controller. The compiler then makes the circuit information holding and configuration controller incorporate and configure that circuit information into the reconfigurable processing device when the processor executes the configuration instructions. When the execution instructions are executed, the reconfigurable processing device executes processing contents indicated by circuit selection information.

Herewith, the reconfigurable processing device (FPGA, etc.) can execute even process contents where the necessary number of configuration cycles cannot be secured, which can improve the performance of the overall system.

And now, on the occasion when an interrupt occurs during execution of the program and different circuit information is incorporated and configured in the reconfigurable processing device (FPGA) in interrupt process, the processor is stopped until it is finished to incorporate and configure the circuit information that is necessary for the reconfigurable processing device, when the execution instructions are executed after returning from the interrupt processing. The present invention has an embodiment corresponding to this case.

In this embodiment, the compiler comprises:

a first judgment unit for judging whether or not there is branch processing in the execution program in compiling the source program;

a second judgment unit for judging whether or not the branch destination of branch processing is decided upon receiving the judgment result from the first judgment unit;

a third judgment unit for judging whether or not there is an execution instruction in ascending order of placement address with the branch destination as a base point upon receiving the judgment result of the second judgment unit; and

an incorporating unit for incorporating a configuration instruction constituting the circuit information, that is indicated by the execution instruction, into the branch destination, upon receiving the judgment result of the third judgment unit.

When the compiler searches for branch conditions from the intermediate code in compiling the source program and a branch destination is decided, the instruction for incorporating into the reconfigurable processing device (FPGA, etc.) to be configured is incorporated at the branch destination. By doing so, even when a branch occurs in implementing the execution program, since a configuration instruction, that incorporates circuit information needed by the execution instruction that is executed first after branching, into the reconfigurable processing device to be configured, is incorporated into the branch destination, the circuit information needed by the execution instructions can begin to be incorporated into the reconfigurable processing device to be configured, thus loss due to the number of cycles during which the processor has to wait can be reduced.

As has been explained above, according to this invention, the compiler complies a source program using circuit information that is stored in a circuit information library, so there is no need to develop circuits to incorporate for configuring (configuration) into the reconfigurable processing device every source program.

Also, circuit information that is necessary for executing the execution instructions is dynamically incorporated into the reconfigurable processing device for configuring, so only circuits that are necessary for executing the process contents are incorporated into the reconfigurable processing device for configuring, and thus it is good enough to prepare a small-scale reconfigurable processing device.

Moreover, the compiler separates process contents into the ones to be executed by the processor and the reconfigurable processing device respectively so as to reduce the number of process cycles of the overall program, so the source program can be executed at high speed.

Furthermore, even when a branch or interrupt occurs, and the execution instructions are executed in a state where circuit information, that is different from the one needed by the execution instructions, is incorporated into the reconfigurable processing device for configuring, the circuit information needed by the execution instructions can be incorporated and configured from there beforehand and the process contents executed.

Also, when a branch or interrupt occurs, and a configuration instruction is executed to incorporate a circuit information into the reconfigurable processing device for configuring while incorporating the same arbitrary circuit information in the reconfigurable processing device for configuring, the execution instructions can be executed without considering the number of configuration cycles by ignoring the configuration instructions on and after the second time.

Moreover, the reconfigurable processing device (FPGA, etc.) can execute process contents that cannot secure the necessary number of configuration cycles, and thus it becomes possible to improve the performance of the overall system.

Furthermore, after returning from interrupt processing, the circuit information that was incorporated and configured before the interrupt occurred can be immediately incorporated into the reconfigurable processing device (FPGA, etc.) for configuring as circuit information needed by the execution instructions, so it is possible to reduce loss due to the number of cycles during which the processor has to wait.

Also, even when a branch occurs during executing the execution program, a configuration instruction for incorporating circuit information needed by the execution instruction that is executed first after branching, into the reconfigurable processing device for configuring, is incorporated at the branch destination, so before executing the execution instructions, the circuit information needed by the execution instructions can begin to be incorporated into the reconfigurable processing device for configuring, thus it is possible to reduce loss due to the number of cycles during which the processor has to wait.

As described above, according to the present invention, processing that was executed conventionally using a FPGA and processor having large-scale circuitry can be executed with a FPGA and processor having small-scale circuitry, so the cost for introducing the FPGA can be suppressed, which is possible to provide a more inexpensive semiconductor integrated circuit device. Also, circuit information that is stored in a circuit information library is used for executing process contents by the FPGA, so there is no need to design a special circuit every source program, which is able to shorten development time and reduce development cost. Moreover, since the source program is executed using circuit information from a versatile circuit information library instead of its dedicated circuit, a compiler device and semiconductor integrated circuit device that are capable of executing various source programs can be provided.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention

FIG. 1 is a system configuration diagram of a compiler device and semiconductor integrated circuit device of a first embodiment of the invention;

FIG. 2 is a diagram showing the data structure of a circuit information library of a first embodiment of the invention;

FIG. 3 is a diagram showing an example of a circuit information library of a first embodiment of the invention;

FIG. 4 is a diagram showing the data structure of a processor execution cycle list of a first embodiment of the invention;

FIG. 5 is a diagram showing an example of a processor execution cycle list of a first embodiment of the invention;

FIG. 6 is a flowchart that shows the compilation process of the source program of the compiler of a first embodiment of the invention;

FIG. 7 is a detailed flowchart of step ST40 of the compilation process of the source program of the compiler of a first embodiment of the invention;

FIG. 8 is a diagram that shows an example of intermediate code of a first embodiment of the invention;

FIG. 9 is a diagram showing the data structure of a circuit information list of a first embodiment of the invention;

FIG. 10 is a diagram showing the data structure of an address list of a first embodiment of the invention;

FIG. 11 is a diagram showing an example of a circuit information list of a first embodiment of the invention;

FIG. 12 is a diagram showing an example of an address list of a first embodiment of the invention;

FIG. 13 is a diagram showing an example of intermediate code when the compilation process is executed up to step ST60 by the compiler of a first embodiment of the invention;

FIG. 14 is a diagram showing an example of intermediate code when the compilation process is executed up to step ST70 of the compiler of a first embodiment of the invention;

FIG. 15 is a detailed block circuit diagram of a semiconductor integrated circuit device of a first embodiment of the invention;

FIG. 16 is a diagram showing the data structure of a circuit information library of a second embodiment of the invention;

FIG. 17 is a diagram showing an example of a circuit information library of a second embodiment of the invention;

FIG. 18 is a detailed flowchart of step ST40 of the compilation process of the source program of the compiler of a second embodiment of the invention;

FIG. 19 is a diagram showing an example of intermediate code of a second embodiment of the invention.

FIG. 20 is a diagram showing an example of intermediate code when the compilation process is executed up to step ST30 by the compiler of a second embodiment of the invention;

FIG. 21 is a diagram showing an example of intermediate code when the compilation process is executed up to step ST408 by the compiler for “mulu d1, d3” of a second embodiment of the invention;

FIG. 22 is a diagram showing an example of intermediate code when the compilation process is executed up to step ST408 by the compiler for “div d1, d2” of a second embodiment of the invention;

FIG. 23 is a diagram showing an example of intermediate code when the compilation process is executed up to step ST410 by the compiler for “mul d2, d3” of a second embodiment of the invention;

FIG. 24 is a diagram showing an example of intermediate code when the compilation process is executed up to step ST409 by the compiler for “mul d0, d1” of a second embodiment of the invention;

FIG. 25 is a diagram showing an example of a circuit information list of a second embodiment of the invention;

FIG. 26 is a diagram showing an example of an address list of a second embodiment of the invention;

FIG. 27 is a diagram showing an example of intermediate code when the compilation process is executed up to step ST60 by the compiler of a second embodiment of the invention;

FIG. 28 is a diagram showing an example of intermediate code when the compilation process is executed up to step ST70 by the compiler of a second embodiment of the invention;

FIG. 29 is a diagram showing an example of intermediate code of a third embodiment of the invention;

FIG. 30 is a flowchart showing the compilation process of the source program of a compiler of a fourth embodiment of the invention;

FIG. 31 is a diagram showing an example of intermediate code when the compilation process is executed up to step ST70 by the compiler of a fourth embodiment of the invention; and

FIG. 32 is a diagram showing an example of intermediate code when the compilation process is executed up to step ST75 by the compiler of a fourth embodiment of the invention.

### DETAILED DESCRIPTION OF THE INVENTION

Hereinafter, the preferred embodiments of the system ON chip according to the invention will be explained in detail with reference to the drawings.

### Embodiment 1

### System Configuration

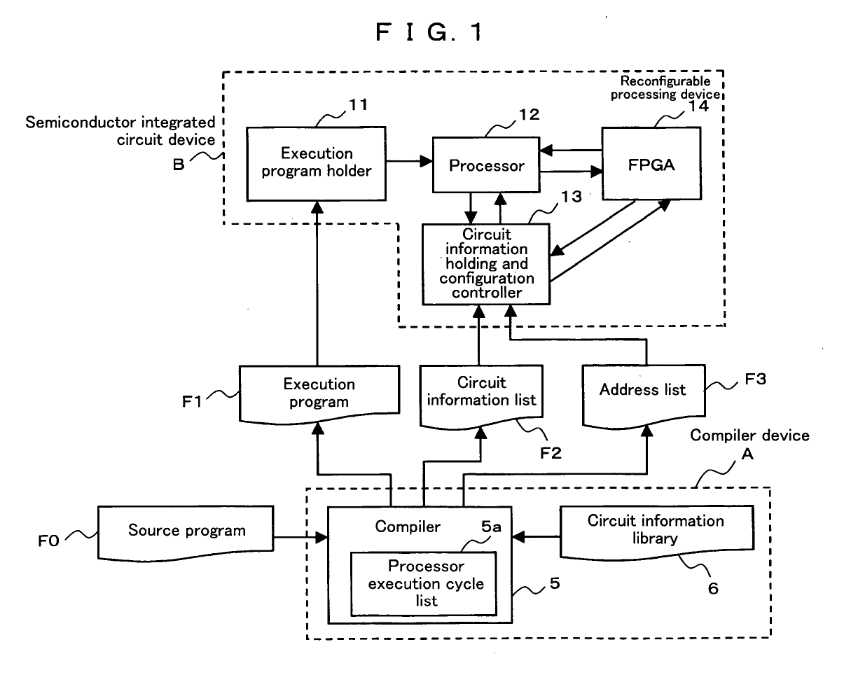

FIG. 1 is a system diagram of a compiler device and semiconductor integrated circuit device of a first embodiment of the invention. As shown in the drawing, the system of this embodiment comprises a compiler device A and semiconductor integrated circuit device B. The compiler device A comprises a compiler 5 and circuit information library 6. The circuit information library 6 stores circuit information for configuring a FPGA 14. The FPGA 14 functions as a reconfigurable processing device in the semiconductor integrated circuit device B. The reconfigurable processing device will be explained later. Here, the circuit information is data for configuring the FPGA 14, and specific processing contents are executed with the FPGA 14 based on the circuit information. Configuration means that the circuit information is incorporated into the FPGA to configure a circuit. The compiler 5 has a processor execution cycle list 5a that contains the number of clock cycles that will become necessary when the processor that will be described later executes each of the processing contents. The compiler 5 is constructed so that it refers to the circuit information library 6 and processor execution cycle list 5a and compiles a source program F0, and creates an execution program F1, a circuit information list F2 and address list F3. The source program F0 is a program that is written in a high-level language.

The semiconductor integrated circuit device B comprises an execution program holder 11, processor 12, circuit information holding and configuration controller 13 and FPGA 14 as a reconfigurable processing device. The execution program holder 11 holds the contents of the execution program F1 that is created by the compiler 5. The processor 12 operates according to the execution program that is read from the execution program holder 11. The circuit information holding and configuration controller 13 holds the contents of the circuit information list F2 and the address list F3. The compiler 5 creates these lists. The circuit information holding and configuration controller 13 has the function of configuring circuit information specified by the processor 12 in the FPGA 14. The FPGA 14 is configured based on circuit information that is transferred from the circuit information holding and configuration controller 13. This process is executed based on an instruction from the processor 12.

It is not shown in the FIG. 1, however, there may be logic circuits or analog circuits in addition to the processor 12 and FPGA 14, the processing of which can be controlled in the same way as a conventional semiconductor integrated circuit device. Also, in this embodiment, the semiconductor integrated circuit device B is not one chip, however may be constructed with one chip.

—Data Structure of the Circuit Information Library—

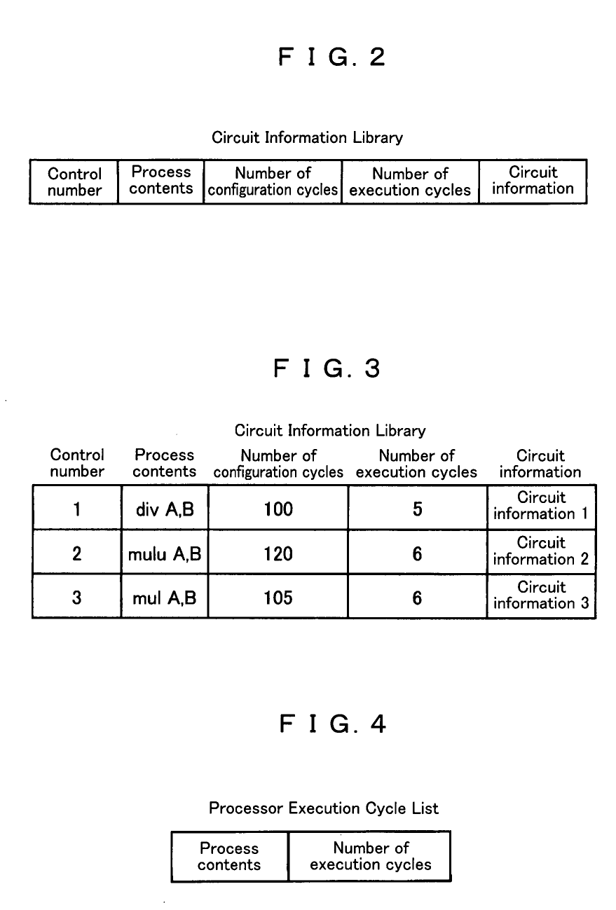

The circuit information library 6 shown in FIG. 1 is prepared beforehand, and here, it stores circuit information for configuring the FPGA 14. FIG. 2 shows the data structure of the circuit information library 6. In addition to circuit information, the circuit information library 6 stores control numbers for the circuit information, process contents that can be executed according to circuit information, the number of configuration cycles necessary for configuring circuit information, and the number of execution cycles necessary for executing the process contents based on circuit information.

FIG. 3 shows an example of a circuit information library 6. The process contents “div”, “mulu” and “mul” indicate instructions that can be executed by the FPGA 14, and are instructions for executing division, unsighed multiplication, and sighed multiplication respectively. Also, “A” and “B” of the process contents “A, B” indicate registers, immediate values, or memory addresses, and indicate executing an instruction using those. In the example shown in FIG. 3, the circuit information 1 with control number 1 executes the process contents “div A,B” (dividing A by B) in 5 cycles, and indicates that 100 cycles are necessary for configuring the circuit information 1 in the FPGA 14.

—Data Structure of a Processor Execution Cycle List—

FIG. 4 shows the data structure of the processor execution cycle list 5a of the compiler 5. The processor execution cycle list 5a comprises process contents that can be executed by the processor 12, and the number of execution cycles necessary for executing the process contents by the processor 12.

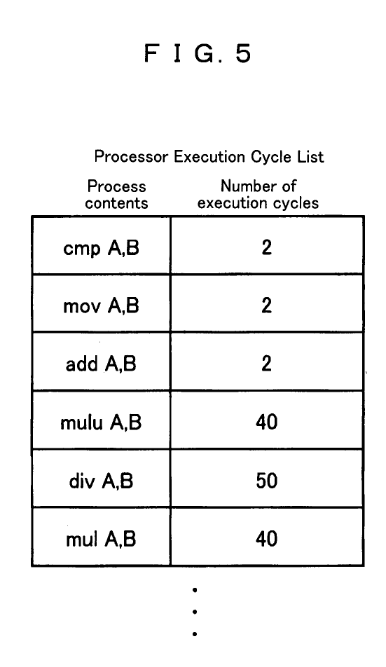

FIG. 5 shows an example of a processor execution cycle list 5a. The process contents “cmp”, “mov” and “add” indicate instructions that can be executed by the processor 12, and are instructions that execute comparison, transfer and addition, respectively. The process contents “mulu”, “div” and “mul” are the same as those explained using FIG. 3. Also, “A” and “B” of the process contents “A, B” indicate registers, immediate values, or memory addresses, and indicate executing an instruction using those. In the example shown in the first line of FIG. 5, two cycles are necessary for the processor 12 to execute “cmp A,B (compare A and B)”.

—Compiler Process—

The compiler 5 shown in FIG. 1 is assumed to

reads the source program F0 and creates intermediate code; and

refers to the circuit information library 6 and processor executing cycle list 5a for each of the processing contents of the intermediate code, and separates the process contents that will improve the execution speed of the execution program F1 as process contents to be executed by the FPGA 14 from the other process contents.

The compiler 5 performs the following series of processes:
Extracts circuit information from the circuit library 6 that is necessary for executing the process contents that are determined as those to be executed by the FPGA 14.
Creates a circuit information list F2 from the extracted circuit information

Creates an address list F3 that indicates addresses where each of circuit information in the circuit information list F2 is stored.

Replaces the process contents determined as those to be executed by the FPGA 14 with FPGA execution instructions.

Calculates the placement address of the intermediate code where the configuration of circuit information necessary for executing the FPGA execution instructions should start, and incorporates the FPGA configuration instruction at the calculated placement address.

Generates code and then creates an execution program F1.

The FPGA configuration instruction is executed with the processor 12, and it outputs an instruction to the circuit information holding and configuration controller 13. The instruction here is an instruction for configuring the circuit information that is indicated in the FPGA configuration instruction, with the FPGA 14. On the other hand, through executing the FPGA execution instruction with the processor 12, data and addresses that are necessary for executing the process contents are transferred to the FPGA 14. The FPGA 14 executes the respective process contents. After the FPGA 14 finishes executing the respective process contents, the FPGA 14 transfers the execution results to the processor 12. The processing by the processor 12 in executing the FPGA configuration instruction and FPGA execution instruction is explained in detail later.

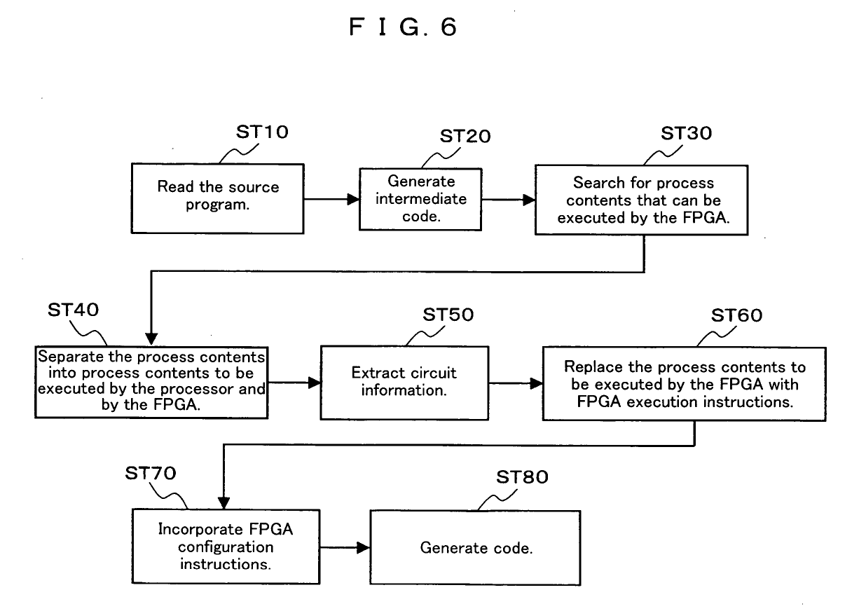

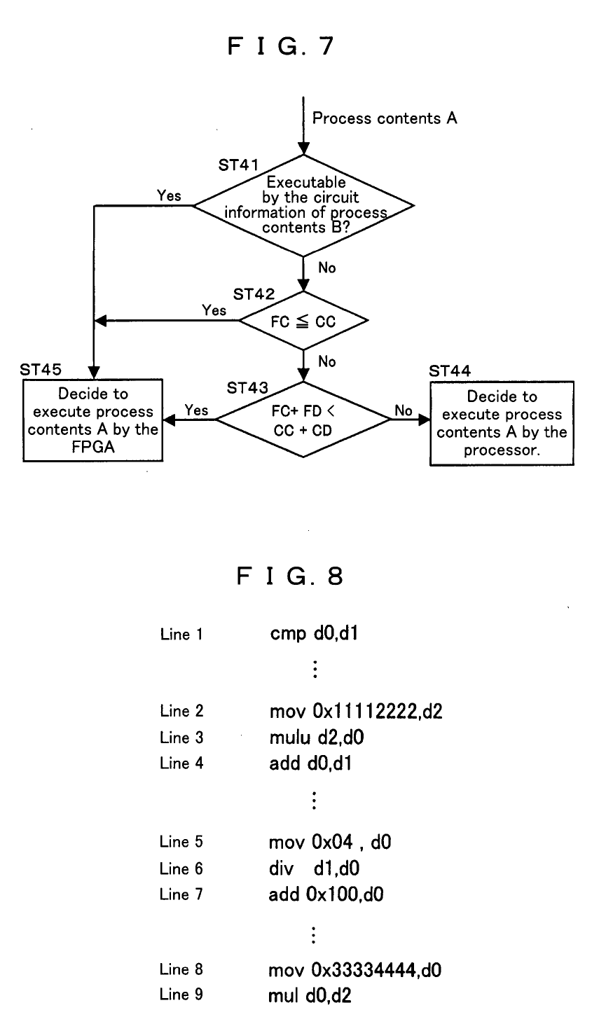

FIG. 6 is a flowchart showing the process compiling the source program F0 with the compiler 5. Also, FIG. 7 shows a detailed flowchart of step ST40 in FIG. 6. Hereinafter, the processing by the compiler 5 will be explained with reference to FIG. 6 and FIG. 7.

The compiler 5 compiles the source program according to the procedure of steps ST10 to ST80. More specifically, an explanation of each step is given later in an example of a compiler processing.

Step ST10: The compiler reads the source program F0.

Step ST20: After going through a lexical analysis routine, a syntax analysis routine, semantic analysis, intermediate code generation routine and code optimization routine, the compiler 5 generates intermediate code from the source program F0 that was read in step ST10 (for example, see FIG. 8). The intermediate code can be assembly language.

Step ST30: The compiler 5 searches the circuit information library 6 as follows. That is, the compiler 5 extracts process contents, that are included in the intermediate code generated in step ST20 and also can be executed by the FPGA 14, from the circuit information library 6. In FIG. 8, for example, “mulu d2, d0” on the third line, “div d1, d0” on the sixth line and “mul d0, d2” on the ninth line are extracted as the aforementioned process contents. With respect to process contents that are not contained in the circuit information library 6 and cannot be extracted from the circuit information library 6 it is assumed that they are executed with the processor 12.

Step S40: The compiler 5 selects process contents that were extracted by the search process of step ST30 as follows. In other words, the compiler 5 determines whether the process is to be executed by the FPGA 14 or by the processor 12 for each of the process contents. This judgment is performed in ascending order of placement addresses in the intermediate code. After this judgment has been completed for all of the process contents that are the object of the judgment, the compiler 5 advances to step ST50. To say that a process ‘can be executed’ means that there is a possibility of execution, but does not necessarily mean that the process will be executed. The processing of step ST40 is shown in detail in steps ST41 to ST45 in FIG. 7. With respect to the terms used in the explanation of steps ST41 to ST45, process contents, which are the object for the judgment whether the process contents are to be executed by the FPGA 14 or by the processor 12, are defined as process contents A. Also, with respect to the process contents A that are defined in this way, processing contents, that satisfy the conditions described below, are defined as the process contents B:

having a placement address that is the shortest address in descending order (closest); and

being decided as process contents that have to be executed by the FPGA 14 in step ST45 of the last judgment

Therefore, the process contents B is concerned with FPGA 14.

Step ST41: The compiler 5 judges whether or not the process contents A are executable with the circuit information of process contents B. In other words, this judgment is judgment whether the circuit information of the process contents A that are the object of this judgment at this time are the same as the circuit information of process contents B determined precedently, further in other words, it is judgment whether or not the number of the circuit information of the process contents A (“1”, “2” or “3” in the circuit information shown in FIG. 3) is the same as the number of the circuit information of process contents B. When it is determined in step ST41 that the process contents are executable, processing advances to step ST45, and when it is determined that the process contents are not executable, processing advances to step ST42, respectively. When there are no process contents that correspond to the process contents B, processing advance unconditionally to step ST42.

Step ST42: The compiler 5 determines whether or not it is possible to secure a sufficient number of configuration cycles for configuring the circuit information necessary for executing process contents A in the FPGA 14. More specifically, the compiler 5 compares the value of the number of cycles CC that are necessary for executing process contents located between process contents B and process contents A by the processor 12 with the value of the number of configuration cycles FC of the circuit information library 6. In this comparison, when it is determined that the condition FC≦CC is not approved (the number of configuration cycles FC cannot be sufficiently secured), the compiler 5 advances to step ST43, and when it is determined that the aforementioned condition is approved (the number of configuration cycles FC can be sufficiently secured), processing advances to step ST45. When there are no process contents that correspond to the process contents B, the number of cycles necessary for the processor 12 to execute the process operation starting from the process contents closest to the headmost placement address of the execution program through the process contents located at the placement address just before process contents A is taken to be the number of cycles CC.

Step ST43: The compiler 5 determines which is faster, a process of performing process contents A in a first mode process #1 or a process of performing process contents A in a second mode process #2. The first mode process #1 is a process of executing the process contents A by the processor 12. The second mode process #2 is a process of stopping operation of the processor 12 until the process of configuring the circuit information in the FPGA 14 is finished, and then executing the process contents A by the FPGA 14, after configuration is finished. The judgment in step ST43 is performed based on whether or not the condition FC+FD<CC+CD is approved. Here, the number of execution cycles in executing process contents A by the processor 12 is taken to be CD, and the number of execution cycles when the process contents are executed by the FPGA 14 is taken to be FD. When the aforementioned condition is approved (the second mode process #2 is faster), processing advances to step ST45, and when the condition is not approved (the first mode process #1 is faster), processing advances to step ST44.

Step ST44: The compiler 5 decides to execute the process contents A by the processor 12.

Step ST45: The compiler 5 decides to execute the process contents A by the FPGA 14.

Step ST50: The compiler 5 extracts circuit information necessary for executing the process contents that were decided in step ST40 to be executed by the FPGA 14 from the circuit information library 6. Extraction is performed in order of control number. The compiler 5 creates a circuit information list F2 and address list F3 based on the extracted circuit information.

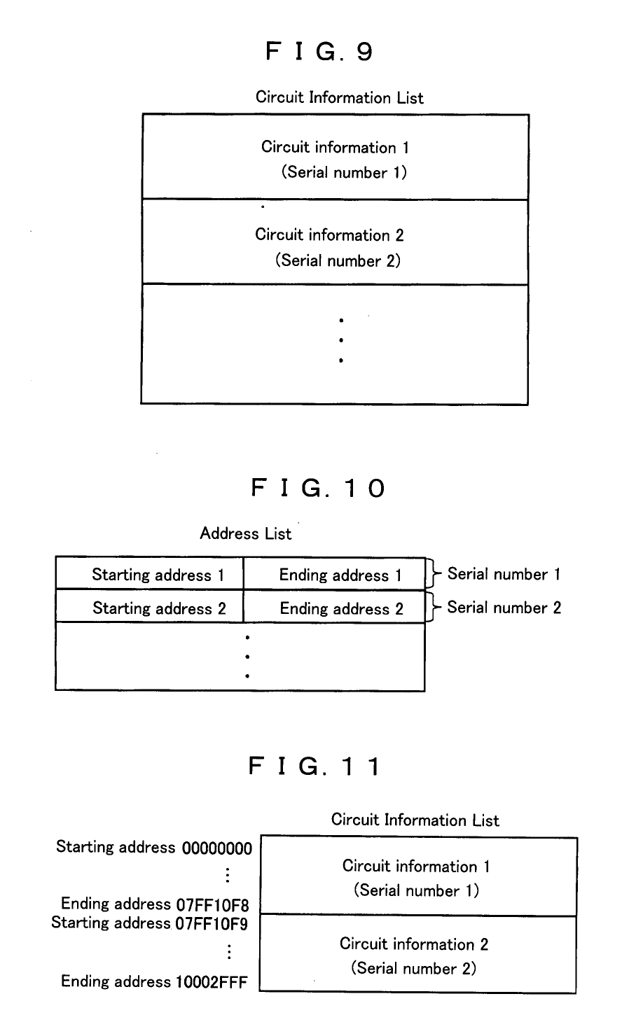

FIG. 9 is a drawing showing the data structure of a circuit information list F2. Serial numbers are assigned to circuit information extracted from the circuit information library 6 in order of control number. The serial numbers are numbers used by the compiler 5 to identify the circuit information that was extracted from the circuit information library 6. The circuit information list F2 consists of circuit information that is necessary for executing the process contents that were decided to execute with the FPGA 14 in step ST40.

FIG. 10 is a drawing showing the data structure of an address list F3. The address list F3 includes starting addresses and ending addresses where circuit information necessary for executing the process contents, that were decided in step ST40 to be executed by the FPGA 14, are stored. Each of starting address and ending address corresponds to the starting address and ending address of each circuit information that is stored in the circuit information list F2.

Step ST60: The compiler 5 replaces the process contents that were decided in step ST40 to be executed by the FPGA 14 with respective FPGA execution instructions (see “fpgad 2, d2, d0”, and “fpgad 1, d1, d0” in FIG. 13).

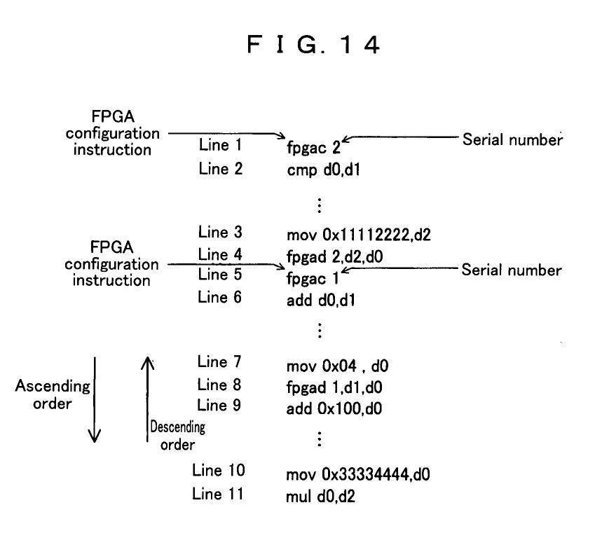

Step ST70: In FPGA 14, the compiler 5 judges the placement address where configuration of the circuit information used by each of the FPGA execution instructions in the intermediate code begins. And then, the compiler 5 incorporates FPGA configuration instructions (see “fpgac 1” and “fpcac 2” in FIG. 14) into the placement addresses determined as the configuration starting addresses. In this step, after searching for FPGA execution instructions in ascending order from the starting address of the placement address, the compiler incorporates FPGA configuration instructions, which configure the circuit information used by the FPGA execution instructions that were extracted from the search, into the a placement address judged as a configuration starting addresses. Hereinafter, FPGA execution instructions that are the object of the judgment in this process are defined as FPGA execution instructions A, and FPGA execution instructions that are located in the shortest distance in descending order from the placement address of the FPGA execution instructions are defined as FPGA execution instructions B. The compiler 5 incorporates FPGA configuration instructions (see “fpgac 1”, “fpgac 2” in FIG. 14) having the same serial numbers as the serial numbers indicated by the FPGA execution instructions A (“2” in “fpgad 2”, or “1” in “fpgad 1” in FIG. 13 is the serial numbers) after the placement address of the FPGA execution instructions B.

Step ST80: After passing though a code generation routine, the compiler 5 creates an execution program F1.

—Compiler Processing Example—

Hereinafter, the processing of this embodiment will be explained using an example of the flow where the compiler 5 generates the intermediate code shown in FIG. 8 from the source program F0, and then creates an execution program F1, circuit information list F2 and address list F3 referring to a circuit information library as shown in FIG. 3 and a processor execution cycle list as shown in FIG. 5. In FIG. 8, “d0”, “d1” and “d2” indicate data registers, and “0x11112222”, “0x04” and “0x33334444” indicate immediate values. Each of the instructions shown in FIG. 8 is the same as the contents explained using FIG. 3 and FIG. 5.

Step ST10: The compiler 5 reads the source program.

Step ST20: The compiler 5 generates an example of the intermediate code shown in FIG. 8.

Step ST30: The compiler 5 searches for process contents which are executable with the FPGA 14 in an example of the intermediate code shown in FIG. 8, referring to the circuit information library shown in FIG. 3 and the processor execution cycle list shown in FIG. 5. In this example, the compiler 5 judges that “mulu d2, d0” on the third line in FIG. 8, “div d1, d0” on the sixth line and “mul d0, d2” on the ninth line are process contents that can be executed by the FPGA 14 (process contents “mulu”, “div” and “mul” exist in the circuit information library shown in FIG. 3). Additionally, it is assumed that the other process contents are executed with the processor 12.

Step ST40: With respect to the process contents “mulu d2, d0” on the third line of FIG. 8, “div d1, d0” on the sixth line and “mul d0, d2” on the ninth line, the compiler 5 judges whether it is executed with the FPGA 14 or it is executed with the processor 12. This judgment is performed along the order of placement of process contents in ascending order (proceeding downward) of placement addresses in the intermediate code. The processing of step ST40 (more specifically, the processing of steps ST41 to ST45) is performed for each of the process contents. First, the processing of step ST40 is performed to the process contents “mulu d2, d0” on the third line. Hereinafter, the details are explained as the processing of steps ST41 to ST45.

Step ST41: Looking in descending order (downward) from the placement address of the process contents “mulu d2, d0”, there are no process contents that can be decided to be executed by the FPGA 14, so processing advances to step ST42.

Step ST42: With respect to the process contents “mulu d2, d0” on the third line, the compiler 5 calculates the number of cycles CC that are necessary when executing from the first line “cmp d0, d1” to the second line “mov 0x11112222, d2” with the processor 12. Here, it is presumed that the calculated number of cycles CC is 150 cycles. In this case, presuming that the number of configuration cycles FC of the circuit information library 6 is 120 cycles, the compiler 5 determines that the condition FC≦CC is approved (it is possible to secure the number of configuration cycles FC sufficiently), and advances to step ST45.

Step ST45: The compiler 5 decides to execute the process contents “mulu d2, d0” by the FPGA 14.

Next, the compiler performs the process of step ST40 to the process contents “div d1, d0” on the sixth line.

Step ST41: Referring to FIG. 3, the compiler 5 determines that the process contents “mulu d2, d0” on the third line are executable using circuit information 2, but that the process contents “div d1, d0” on the sixth line are not executable using circuit information 2, then advances to step ST42.

Step ST42: With respect to the process contents “div d1, d0”, the compiler 5 calculates the number of cycles CC that are necessary for executing from the process contents “add d0, d1” on the fourth line to the process contents “move 0x04, d0” on the fifth line by the processor 12. Here, it is presumed that the calculated number of cycles CC is 80 cycles. In this case, presuming that the number of configuration cycles FC of the circuit information library 6 is 100 cycles, the compiler 5 determines that the condition FC≦CC is not approved (it is not possible to secure the number of configuration cycles FC sufficiently), and advances to step ST43.

Step ST43: The compiler 5 determines which is faster, the process of performing process contents “div d1, d0” through first mode processing #1, or the process of performing process contents “div d1, d0” through second mode processing #2. Here, the first mode processing #1 is a process of executing the process contents by the processor 12. The second mode process #2 is a process of stopping operation of the processor 12 until the process of configuring the circuit information in the FPGA 14 is finished, and then after configuration is finished, executing the process contents by the FPGA 14. For the process contents “div d1, d0”, presuming that FC is 100 cycles, FD is 5 cycles, CC is 80 cycles and CD is 40 cycles, the condition FC+FD<CC+CD is approved, so the compiler 5 determines that the second mode processing #2 is faster than the first mode processing #1, then advances to step ST45.

Step ST45: The compiler 5 decides to execute process contents “div d1, d0” by the FPGA 14. Finally, the compiler 5 performs the processing of step ST40 to the process contents “mul d0, d2” on the ninth line.

Step ST41: Referring to FIG. 3, the compiler 5 determines that the process contents “div d1, d0” on the sixth line are executed using circuit information 1, but that the process contents “mul d0, d2” cannot be executed using circuit information 1, and advances to step ST42.

Step ST42: With respect to the process contents “mul d0, d2” on the ninth line, the compiler 5 calculates the number of cycles necessary for executing from the process contents “add 0x100, d0” on the seventh line to the process contents “mov 0x33334444, d0” on the eighth line by the processor 12 as the number of cycles CC. Here, it is presumed that the calculated number of cycles CC is 30 cycles. In this case, presuming that the number of configuration cycles FC of the circuit information library 6 is 105 cycles, the compiler 5 determines that the condition FC≦CC is not approved (it is not possible to secure the configuration cycles FC sufficiently), and advances to step ST43.

Step ST43: The compiler 5 determines which is faster, the process of performing process contents “mul d0, d2” by first mode processing #1, or the process of performing process contents “mul d0, d2” by second mode processing #2. Presuming that FC is 105 cycles, FD is 6 cycles, CC is 30 cycles and CD is 40 cycles in the process contents “mul d0, d2”, the condition FC+FD<CC+CD is not approved, so the compiler 5 determines that the second mode processing #1 is faster than the first mode processing #2, and advances to step ST44.

Step ST44: The compiler 5 decides to execute the process contents “mul d0, d2” by the processor 12.

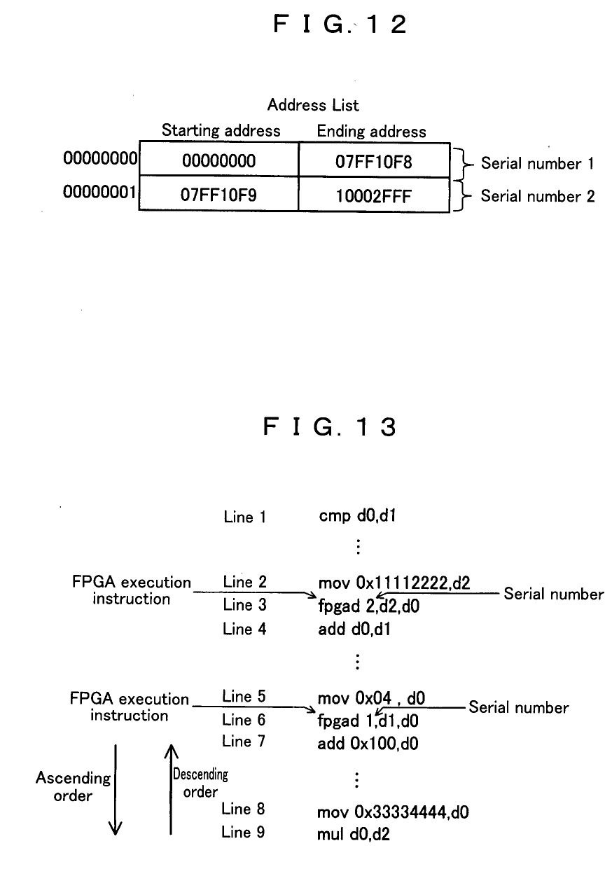

Step ST50: The compiler 5 creates a circuit information list F2 obtained by extracting the circuit information 1, 2 that is necessary for executing the process contents “mulu d2, d0” on the third line and the process contents “div d1, d0” on the sixth line that were decided in step ST40 to be executed by the FPGA 14. FIG. 11 shows an example of a circuit information list F2 where circuit information 1, 2 was extracted from the circuit information library 6. The numerical values on the left side of FIG. 11 indicate addresses where the circuit information is stored. The compiler 5 creates an address list F3 that indicates the addresses where the circuit information extracted in this step is stored. FIG. 12 shows an example of an address list F3 that indicates the starting addresses and ending addresses where the circuit information 1, 2 is stored. The numerical values on the left side of FIG. 12 show the addresses where the starting addresses and ending addresses are stored. In addition, the compiler 5 could create the circuit information list F2 and address list F3 to correspond with the specifications of the circuit information holding and configuration controller 13. In extracting circuit information 1, 2, the compiler assigns serial numbers 1, 2 to the extracted circuit information 1, 2.

Step ST60: The compiler 5 replaces the process contents “mulu d2, d0” on the third line and the process contents “div d1, d0” that were decided in step ST40 to be executed by the FPGA 14 with FPGA execution instructions. FIG. 13 shows an example of the intermediate code that is obtained by executing the process up through step ST60. In FIG. 13, “fpgad” is one example of an FPGA execution instruction. The number “2” that is indicated by “fpgad” in the third line indicates the serial number corresponding to circuit information 2, and “d2, d0” indicate the data registers that are necessary for executing the process contents “mulu d2, d0”. The FPGA execution instruction “fpgad” in the sixth line is the FPGA execution instruction of circuit information 1 that corresponds to serial number “1”.

Step ST70: When configuring the FPGA 14 with the circuit information that is necessary for executing the FPGA execution instructions, determining where the placement address for starting configuration is set is performed as follows. That is, in the case of “fpgad 2, d2, d0”, looking in descending order from the placement address of “fpgad 2, d2, d0”, there are no process contents to be executed by the FPGA 14. Therefore, the starting address for configuration is set before “cmp d0, d1” on the first line. Also, in the case of “fpgad 1, d1, d0”, since “fpgad 2, d2, d0” on the third line exists at the shortest distance as process contents to be executed by the FPGA 14 in descending order from the placement address of “fpgad 1, d1, d0”, the next placement address is set as a starting address for configuration. The compiler 5 incorporates FPGA configuration instructions, which indicate the serial numbers indicated by each of the FPGA executions instructions, in the configuration starting addresses that are set. FIG. 14 shows an example of the intermediate code that is obtained by executing processing up through step ST70. In the figure, “fpgac” is an example of a FPGA configuration instruction. The number “2” that is indicated by “fpgac” on the first line is the serial number that corresponds to circuit information 2. Similarly, “fpgac” on the fifth line is the FPGA configuration instruction of circuit information 1 that corresponds to serial number 1.

Step ST80: The compiler 5 generates an execution program F1 from the intermediate code that was converted in step ST70.

—Execution Program Holder—

The execution program holder 11 shown in FIG. 1 stores the execution program F1 that includes FPGA configuration instructions (“fpgac . . . ”) and FPGA execution instructions (“fpgad . . . ”). The detailed process when the processor 12 executes FPGA configuration instructions and FPGA execution instructions is explained in the explanation of the FPGA configuration instructions and FPGA execution instructions which will be described later.

—Circuit Information Holding Configuration Controller—

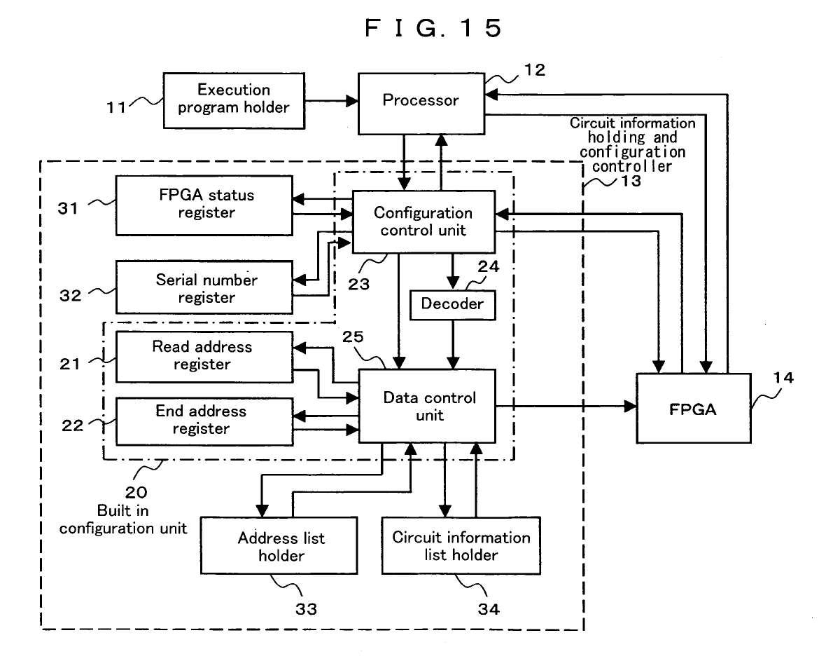

FIG. 15 shows a detailed block circuit diagram of the semiconductor integrated circuit device B that is shown in FIG. 1. The circuit information holding and configuration controller 13 comprises an incorporating and configuration unit 20, FPGA status register 31, serial number register 32, address list holder 33 and circuit information list holder 34. The incorporating and configuration unit 20 comprises a read address register 21, end address register 22, configuration control unit 23, decoder 24 and data control unit 25. The configuration control unit 23 receives instructions from the processor 12 and controls the configuration performed by the FPGA 14. The serial number register 32 stores serial numbers that are transferred from the processor 12. The FPGA status register 31 stores data indicating whether or not configuration performed by the FPGA 14 is finished. The address list holder 33 stores the address list F3 that was created by the compiler 5. The circuit information list holder 34 stores the circuit information list F2 that was created by the compiler 5. The decoder 24 decodes the serial numbers that are stored in the serial number register 32. The decoder 24 decodes serial numbers, and it outputs the addresses for reading out the information of the address list holder 33 corresponding to the respective serial numbers. The read address register 21 submits addresses of circuit information that is read from the circuit information list holder 34. The end address register 22 stores end addresses that are read from the address list holder 33. The data control unit 25 transfers the circuit information that is read from the circuit information list holder 34 to the FPGA 14. The detailed processing flow of the circuit information holding configuration controller 13 is explained in the FPGA configuration instructions and FPGA execution instructions described later.

—FPGA Configuration Instruction—

When the processor 12 executes a FPGA configuration instruction, it transfers the serial number indicated by the FPGA configuration instruction to the configuration control unit 23 of the circuit information holding and configuration controller 13. As an example, when “0” is written in the FPGA status register 31, it indicates that the FPGA 14 is in the progress of configuration, and when “1” is written in the FPGA status register 31, it indicates that configuration of the FPGA 14 is finished. The below example will be described using the above explanation.

The address list holder 33 stores the address list F3 that was created by the compiler 5. The circuit information list holder 34 stores the circuit information list F2 that was created by the compiler 5. The configuration control unit 23 compares the serial number that is transferred from the processor 12 with the values that are stored in the serial number register 32. When the result of the comparison indicates that they have a same value, the configuration control unit 23 advances to processing of the FPGA execution instruction without performing the subsequent process. When the result of the comparison indicates that they are different, the configuration control unit 23 performs the following:

Stores the transferred serial number in the serial number register 32.

Notifies the FPGA 14 that there is a request to start configuration.

Writes “0” in the FPGA status register 31.

The configuration control unit 23 reads the serial number stored in the serial number register 32, and transfers it to the decoder 24. The configuration control unit 23 instructs the data control unit 25 to update the read address register and end address register. After receiving a request from the configuration control unit 23 to start configuration, the FPGA 14 starts configuration using the circuit information that is transferred from the data control unit 25. The decoder 24 decodes the serial number that is input from the configuration control unit 23, and outputs the decoded result to the data control unit 25. The decoded result from the decoder 24 indicates the address in the address list holder 33 that corresponds to the serial number. After receiving the instruction from the configuration control unit 23 to update the read address register 21 and end address register 22, the data control unit 25 outputs the address input from the decoder 24 to the address list holder 33, and stores the read starting address and ending address in the read address register 21 and end address register 22, respectively. When the data control unit 25 has completed storing the starting address and ending address, it outputs the addresses stored in the read address register 21 to the circuit information list holder 34. Further, the data control unit 25 transfers the circuit information that was read from the circuit information list holder 34 to the FPGA 14. After transfer of the read circuit information has been completed, the data control unit 25 compares the value stored in the read address register 21 with the value stored in the end address register 22.

In this comparison, when the value of the read address register 21 is the value of the end address register 22 or less, the data control unit 25 increments the value of the read address register 21 and stores the value in the read address register 21. The data control unit 25 outputs the address that is stored in the read address register 21 to the circuit information list holder 34 again, and transfers the read circuit information to the FPGA 14.

Meanwhile, when the value of the read address register 21 is greater than the value of the end address register 22, the data control unit 25 ends the process for transferring circuit information to the FPGA 14. When the process for transferring circuit information to the FPGA 14, that is, the configuration process ends, the FPGA 14 notifies the configuration control unit 23 that configuration has ended. When the configuration control unit 23 knows that configuration of the FPGA 14 has ended, it writes “1” in the FPGA status register 31.

—FPGA Execution Instruction—

When the processor 12 executes a FPGA execution instruction, it reads the value of the serial number register 32 and the value of the FPGA 14 status register 31 through the data control unit 25. The processor 12 performs the following confirmation.

Determines whether or not the serial number that is indicated by the FPGA execution instruction is the same as the value of the serial number register 32.

Determines whether or not the value of the FPGA status register 31 is “1”.

When the serial number that is indicated by the FPGA execution instruction is different from the value of the serial number register 32, the processor 12 outputs an instruction to the circuit information holding and configuration controller 13 so as to configure the FPGA 14 with circuit information that corresponds to the serial number that is indicated by the FPGA execution instruction. Further, the processor 12 stops its own operation until configuration of the FPGA 14 is completed and the value of the FPGA status register 31 becomes “1”.

On the other hand, when the serial number that is indicated by the FPGA execution instruction is the same as the value of the serial number register 32 and the value of the FPGA status register 31 is not 1, the processor 12 stops its own operation until the configuration of the FPGA 14 is completed and the value of the FPGA status register 31 becomes “1”.

Additionally, when the serial number that is indicated by the FPGA execution instruction is the same as the value of the serial number register 32, and the value of the FPGA status register 31 is “1”, the processor 12 transfers the value, that is stored in the register or immediate value that is necessary for executing the process contents, to the FPGA 14. When it is completed to transfer the value in the register and immediate value to the FPGA 14, the processor 12 stops its own operation. The process contents at that time are executed with the FPGA 14. When execution of the process contents is finished, the FPGA 14 notifies the processor 12 that execution of the process contents is completed and transfers the execution results of the process contents by the FPGA 14 to the processor 12. The processor 12 receives the notification that execution of the process contents by the FPGA 14 is finished, and then starts its own operation again.

According to this embodiment as described above, since the compiler 5 effectively uses circuit information that is stored in the circuit information library 6 to compile a source program F0, it is not necessary to develop a circuit for configuring the FPGA 14 every source program as in the case of the prior art. In other words, as a circuit information library 6 that is prepared in advance is utilized effectively, there is no need to design a special circuit for each source program, and thus the development time is shortened and the development cost is reduced.

Furthermore, configuration of the FPGA 14 with circuit information that is necessary for executing an execution instruction is performed dynamically, so it is good enough to configure the FPGA 14 with only the circuit necessary for executing the process contents, and prepare a small scale of FPGA 14.

Moreover, since a condition is set so that the number of configuration cycles and the number of execution cycles become minimum at the time when the compiler 5 separates process contents into those to be executed by the processor 12 and those to be executed by the FPGA 14, the program can be executed at high speed.

### Second Embodiment

In the first embodiment, in the intermediate code that is generated by the compiler 5 of FIG. 1, in case that the placement addresses of two process contents that can be executed by the FPGA 14 are continuous with each other, or in case that the placement addresses are separated by a small amount, problems may occur. Hereinafter, those problems are explained.

In the first embodiment, when the placement addresses of arbitrary process contents A, B that were determined in step ST30 in FIG. 6 by the compiler to be process contents that can be executed by the FPGA 14 are continuous (the placement address of process contents B is larger than the placement address of process contents A), or when the difference between the placement addresses is small, the following problem may occur. In other words, in this case, regardless of enabling the process contents B to execute with the FPGA 14 much faster, the number of configuration cycles for configuring the FPGA 14 with the circuit information necessary for execution by the FPGA 14 cannot be secured, and therefore, there is a case where it is decided that those process contents should be executed by the processor 12. In that case, it is not possible to improve the processing performance by executing process contents B with the FPGA 14.

Therefore, in this second embodiment, consideration is taken so that even when the placement addresses of process contents A, B are continuous or the difference between the placement addresses is small, process contents B can be executed by the FPGA 14. The system configuration of the present embodiment is described below.

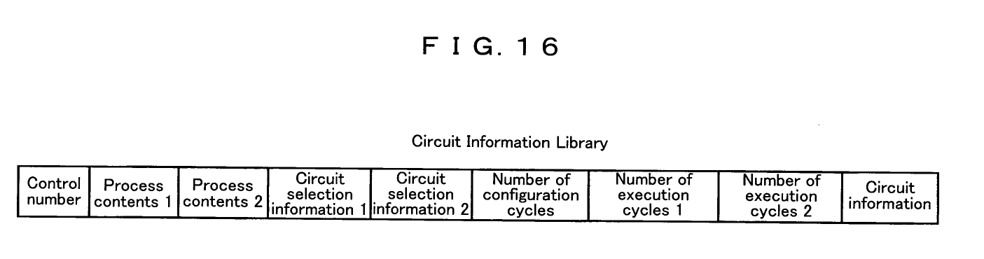

Hereinafter, a system that includes circuit information capable of executing two process contents is explained. FIG. 16 is a diagram showing the data structure of the circuit information library 6 of this embodiment. This data structure differs from the data structure of the circuit information library 6 of the first embodiment in that in the data structure of the circuit information library 6 of this embodiment, the system has two process contents (process contents 1 and process contents 2) that can be executed by the circuit information, two numbers of execution cycles (number of execution cycles 1 and number of execution cycles 2) that are necessary when executing each of the process contents, and two numbers of circuit selection information (circuit selection information 1 and circuit selection information 2) that are added to the FPGA execution instruction when executing each of the process contents by the FPGA 14, respectively. Process contents 1 correspond to the number of execution cycles 1 and circuit selection information 1, and process contents 2 correspond to the number of execution cycles 2 and circuit selection information 2.

The circuit selection information is the information for deciding which, among the process contents that can be executed by the circuit information, is executed by the FPGA 14, and the circuit selection information that corresponds to the process contents requested to be executed is added to the FPGA execution instruction. When the processor executes the FPGA execution instruction, the processor 12 transfers the data, address and circuit selection information that are indicated by the FPGA execution instruction to the FPGA 14, and makes the FPGA 14 execute the process contents that correspond to the circuit selection information. The FPGA 14 then transfers the execution results to the processor 12. The FPGA 14 includes a mechanism for selecting which process content is executed according to the circuit selection information that is transferred from the processor 12.

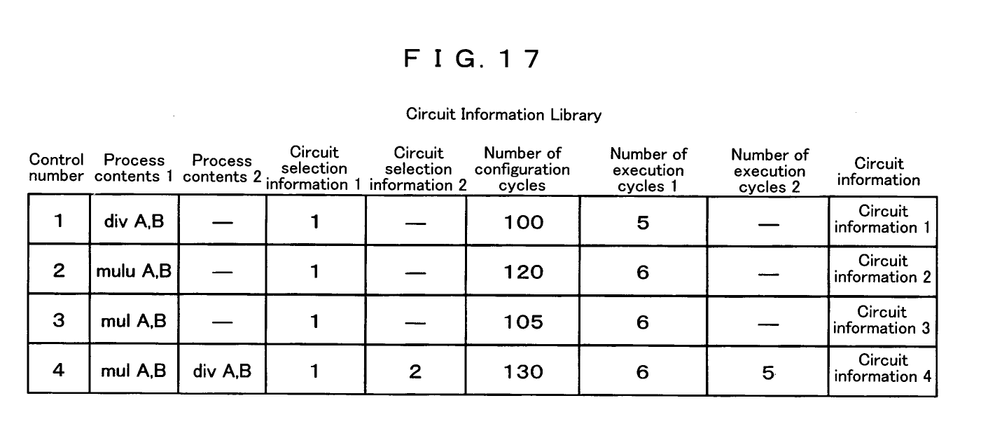

FIG. 17 shows an example of the circuit information library 6 of this embodiment. The explanation of each of the process contents is the same as that of FIG. 3. In the example shown in FIG. 17, the circuit information 4 having control number 4 can execute process contents “mul A, B (multiply A by B)” and “div A, B (divide A by B)” in 6 cycles and 5 cycles, respectively, and when executing each of the process contents using circuit information 4, it is necessary to add circuit selection information “1” and circuit selection information “2” to the FPGA execution instruction, and it is indicated that 130 cycles are necessary to configure the FPGA 14 with circuit information 4. Also, there is a “-” in the items for process contents 2, and the number of execution cycles 2 in control number 1, and this indicates that control information 1 can only execute process contents 1. The same is true for control numbers 2 and 3.

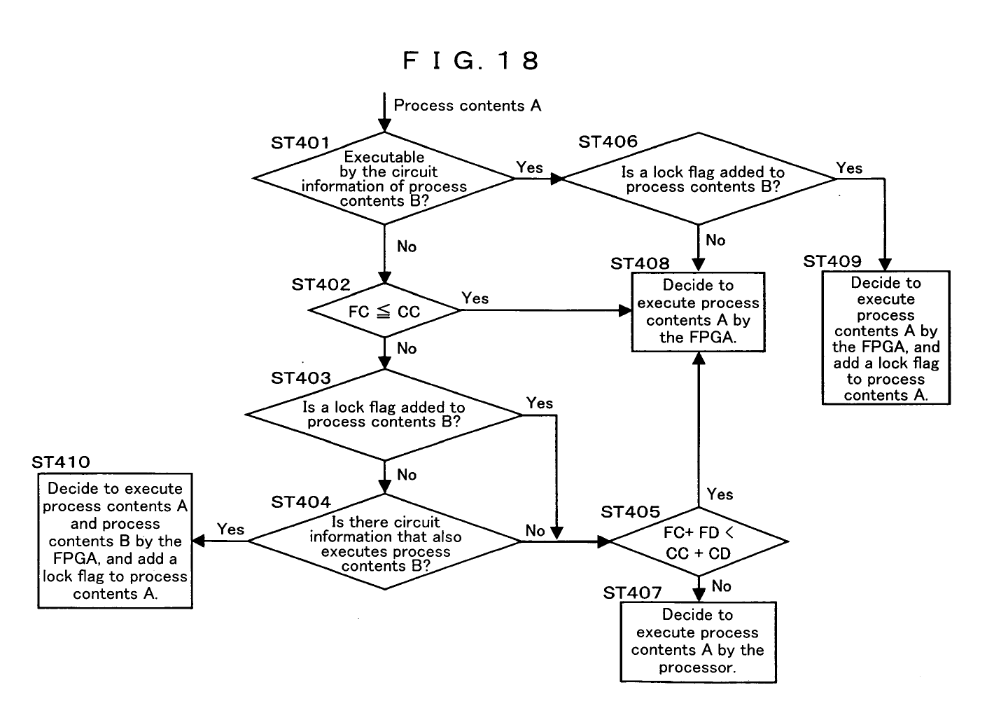

In this embodiment, the flowchart showing the process where the compiler 5 compiles a source program F0 is shown in FIG. 6 same as that of the first embodiment, however, a detailed flowchart in step ST40 is shown in FIG. 18. The compiler 5 of this embodiment compiles the source program F0 according to the procedure from step ST10 to step ST80 of FIG. 6. Steps ST10 and ST 20 are the same as in the first embodiment, so an explanation of them is omitted.

Step ST30: The compiler 5 refers to the circuit information library 6 for each of the process contents in the intermediate code that was generated in step ST20, and searches for process contents that can be executed by the FPGA 14 from process contents 1 and process contents 2 of the circuit information library 6. As a result of searching the circuit information library 6, when the process contents of the intermediate code match the process contents 1 or process contents 2 of the circuit information library 6, the compiler 5 determines that those process contents can be executed by the FPGA 14, and adds the control numbers of all of the circuit information where the process contents match to the intermediate code of the process contents as information. Process contents, which are not described in the circuit information library 6, are executed with the processor 12.

Step ST40: For the process contents that were determined in step ST30 to be capable of being executed by the FPGA 14, the compiler 5 determines for each of the process contents whether they are to be executed by the FPGA 14 or by the processor 12. The judgment process is performed in ascending order of placement addresses in the intermediate code. After the above judgment has been completed for all of the process contents that are judgment targets, processing advances to step ST50. Details of the processing of step ST40 are shown in steps ST401 to ST410 in FIG. 18. In the terminology that is used in the explanation of step ST40, process contents that are the object of the judgment to determine whether they are executed by the FPGA 14 or processor 12 are defined as process contents A, and process contents whose placement address is the shortest distance in descending order looking from the process contents A and are determined in step ST 408 and step ST410 as process contents to be executed by the FPGA 14, are defined as process contents B.

Step ST401: The compiler 5 determines whether or not the process contents A can be executed by the circuit information of process contents B. More specifically, in this judgment, the compiler 5 refers to the circuit information library 6, and determines whether or not the process contents of process contents 1 or the process contents of process contents 2 in the circuit information that is used for executing the process contents B that were previously set, match the process contents A. When it is determined in step ST401 that the process contents A can be executed by the circuit information of process contents B, that can be executed by the FPGA 14, processing advances to step ST406, and when the compiler 5 determines that the process contents A are not executable by the circuit information of process contents B, processing advances to step ST402, respectively. When there are no process contents that correspond to process contents B, processing advances to step ST402.

Step ST402: The compiler 5 determines whether or not a sufficient number of configuration cycles can be secured for configuring the FPGA 14 with circuit information that is necessary for executing process contents A. The circuit information that is the object of the judgment is the circuit information having the smallest number of configuration cycles among the control numbers added to the process contents A as information. The compiler 5 compares the number of cycles CC that are necessary for the processor 12 to execute the process contents that are between process contents B and process contents A with the number of configuration cycles FC in the circuit information library 6, and when the condition FC≦CC is not approved (a sufficient number of configuration cycles cannot be secured), processing advances to step ST403, and when the above condition is approved (a sufficient number of configuration cycles can be maintained), processing advances to step ST408. When there are no process contents that correspond to process contents B (there are no process contents executed by the FPGA 14 in descending order from the placement address of process contents A), the number of cycles that are necessary for the processor 12 to execute from the process contents located at the placement address at the start of the execution program to the process contents located at the placement address just before process contents A is taken to be CC.

Step ST403: The compiler 5 determines whether or not a lock flag is added to process contents B. A lock flag is information that indicates whether or not it is rejected to change circuit information that is used for executing process contents, and it is added to the intermediate code that was decided in step ST409 and ST410 to be executed by the FPGA 14. When a lock flag has been added to the process contents B, processing advances to step ST405, and when a lock flag has not been added, processing advances to step ST404.

Step ST404: The compiler 5 determines whether or not there is circuit information that can execute the process contents A and process contents B. More specifically, this judgment is executed based on judgment whether or not there are added control numbers that are added in common to both the process contents A and process contents B. When there is circuit information that can execute process contents A and process contents B, processing advances to step ST410, and where there is no circuit information that can execute process contents A and B, processing advances to step ST405.

Step ST405: The compiler 5 determines which is faster, processing the process contents A through first mode processing #1, or processing the process contents A through second mode processing #2. First mode processing #1 is a process of executing the process contents A with the processor 12, and second mode processing #2 is a process of stopping the operation of the processor 12 until the configuration process of configuring the FPGA 14 with circuit information is completed and then executing process contents A with the FPGA 14. More specifically, this judgment is performed based on judgment whether or not the condition FC+FD<CC+CD is satisfied. The circuit information that is the object of this judgment is the circuit information that became the object of judgment in step ST402. When the above conditional expression is approved (processing by second mode processing #2 is faster), processing advances to step ST408, and when the above conditional expression is not approved (processing by first mode processing #1 is faster), processing advances to step ST407, respectively.

Step ST406: The compiler 5 determines whether or not a lock flag is added to the process contents B. When it is determined in step ST406 that a lock flag is added, processing advances to step ST409, and when it is determined that a lock flag is not added, processing advances to step ST408, respectively.

Step ST407: The compiler 5 decides to execute process contents A with the processor 12.

Step ST408: The compiler 5 decides to execute process contents A with the FPGA 14 using the circuit information that was the object of the judgment in steps ST402, ST405 and ST406. The compiler 5 newly adds the control number of circuit information that was the object of judgment and the circuit selection information that is necessary for executing process contents A with the circuit information that was the object of judgment to the intermediate code of process contents A as information.

Step ST409: The compiler 5 decides to execute process contents A using the circuit information that was the object of judgment in step ST406. The compiler 5 newly adds the control number of circuit information that was the object of judgment and the circuit selection information that is necessary for executing process contents A with the circuit information that was the object of judgment to the intermediate code of process contents A as information.

Step ST410: The compiler 5 decides to execute process contents A and process contents B with the FPGA 14 using the circuit information that was judged in step ST404. The compiler 5 adds the control number of circuit information that was the object of judgment and the circuit selection information that is necessary for executing the process contents A with the circuit information that was the object of judgment to the intermediate code of process contents A as information. Also, the compiler 5 adds a lock flag to the process contents A. The compiler 5 replaces the control number that is added to process contents B with the same control number as process contents A, and replaces the added circuit selection information with circuit selection information that is necessary for executing process contents B with the circuit information of the replaced control number.

Step ST50: The compiler 5 searches for control numbers that were added to each of the process contents that were decided in steps ST408, ST409 and ST410 to be executed by the FPGA 14, and extracts the circuit information to which the control numbers found by searching have been attached from the circuit information library 6 in order of control number, and then, creates a circuit information list F2 and address list F3 based on that extraction result. When doing this, the compiler 5 assigns serial numbers to the control numbers of the extracted circuit information, and stores the correlation between the serial numbers and control numbers.

Step ST60: The compiler 5 replaces each of the process contents that were decided in steps ST408, ST409 and ST410 to be executed by the FPGA 14 with FPGA execution instructions. The compiler 5 replaces each of the process contents with FPGA execution instructions that indicate the serial numbers that correspond to the control numbers that were added to each process in steps ST408, ST409 and ST410, and the circuit selection information that was added in steps ST408, ST409 and ST410. After replacement has been completed, the compiler 5 deletes the control numbers, circuit selection information and lock flags that were added in step ST40.

Step ST70: The compiler 5 decides the placement addresses of the intermediate code where configuration of the FPGA 14 with the circuit information used by each of the FPGA execution instructions starts, and incorporates FPGA configuration instructions in the decided placement addresses. In this step, the FPGA executions instructions are searched in ascending order from the starting address of the placement addresses, and the compiler 5 incorporates FPGA configuration instructions that perform based on that extraction result of the circuit information that is used by the found FPGA execution instructions into the placement addresses that start configuration.

The method for determining the placement addresses for incorporating FPGA configuration instructions is explained. The terminology that will be used in the below explanation will be described. The FPGA execution instructions that are the object of judgment are defined as FPGA execution instructions A, and the FPGA execution instructions whose addresses is located at a position with the shortest distance in descending order from the placement addresses of the FPGA execution addresses A are defined as FPGA execution instructions B. The compiler 5 determines whether the serial numbers indicated by the FPGA execution instructions A match the serial numbers indicated by the FPGA execution instructions B. More specifically, this judgment is performed based on judgment whether or not the FPGA execution instructions A and FPGA execution instructions B are executed using the same circuit information. When the serial number of a FPGA execution instruction A matches the serial number of a FPGA execution instruction B, the compiler 5 does not incorporate the FPGA configuration instruction (“fpgac . . . ”) into the intermediate code. When the serial number of a FPGA execution instruction A differs from the serial number of a FPGA execution instruction B, the compiler 5 incorporates a FPGA configuration instruction, that indicates the serial number of the FPGA execution instruction, into the placement address after the FPGA execution instruction B. When there are no FPGA execution instructions that correspond to FPGA execution instructions B, the compiler 5 incorporates an FPGA configuration instruction, that indicates the serial number of the FPGA execution instruction A, into the starting address of the intermediate code.

From the judgment described above, when there are continuous FPGA execution instructions that use the same circuit information, there is no need to incorporate FPGA configuration instructions that indicate the same serial number into the intermediate code, thus it is possible to make the size of the execution program F1 smaller.

Step ST80: Passing through a code generation routine, the compiler 5 creates an execution program F1.

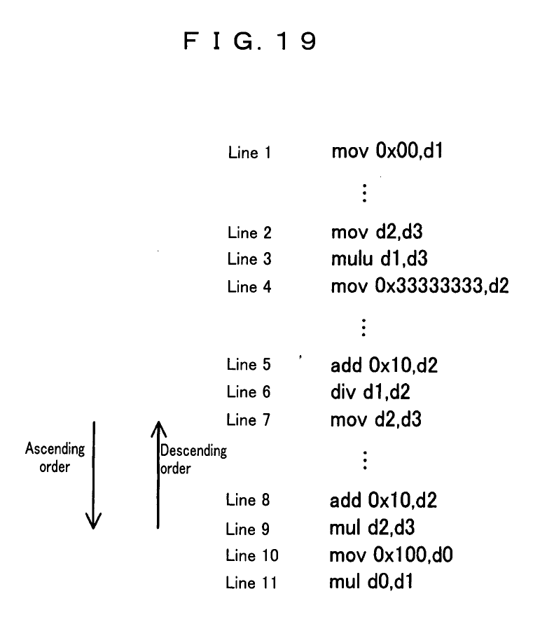

Hereinafter, explained is the flow where the compiler 5 creates the example of intermediate code shown in FIG. 19 from a source code F0, and prepares an execution program F1, circuit information list F2 and address list F3, referring to the circuit information library shown in FIG. 17 and the processor execution cycle list shown in FIG. 5. In FIG. 19, “d0”, “d1”, “d2” and “d3” are data registers, and “0x00”, “0x10”, “0x100”, and “0x33333333” are immediate values. The respective instructions shown in FIG. 19 are the same as the contents explained in FIG. 3 and FIG. 5.

Step ST10: The compiler 5 reads a source program F0.

Step ST20: The compiler 5 generates the example of intermediate code shown in FIG. 19.

Step ST30: The compiler 5 searches for process contents that are executable by the FPGA 14 in the intermediate code shown in FIG. 19, referring to the circuit information library shown in FIG. 17 and the processor execution cycle list shown in FIG. 5. In this example, the compiler 5 determines that the process contents “mulu d1, d3” on the third line in FIG. 19, the process contents “div d1, d3” on the sixth line, the process contents “mul d2, d3” on the ninth line and the process contents “mulu d0, d1” on the eleventh line are executable by the FPGA 14. The process contents “mulu d1, d3” on the third line are executable by circuit information 2, the process contents “div d1, d2” on the sixth line are executable by circuit information 1, 4, the process contents “mul d2, d3” on the ninth line are executable by circuit information 3, 4, and the process contents “mul d0, d1” on the eleventh line are executable by circuit information 3, 4.

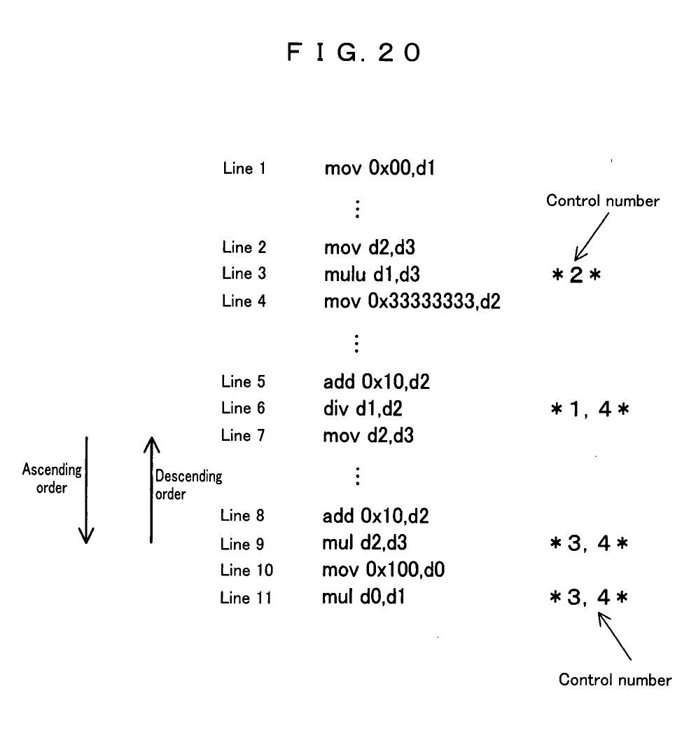

FIG. 20 is an example in which control numbers of circuit information that can execute the aforementioned process contents are added to the intermediate code of the process contents as information, where the values within the asterisks “*” indicate the control numbers. The compiler 5 decides that the process contents other than those described above are executed with the processor 12.

Step ST40: The compiler 5 determines whether each of the process contents is executed by the FPGA 14 or executed by the processor 12 in the order of the process contents “mulu d1, d3” on the third line in FIG. 19, the process contents “div d1, d3” on the sixth line, the process contents “mul d2, d3” on the ninth line and the process contents “mulu d0, d1” on the eleventh line. More specifically, the processing of steps ST401 to ST410 is performed every the process contents. First, the processing of step ST40 (steps ST401 to ST410) in the process contents “mulu d1, d3” on the third line, is explained.

Step ST401: There is no process contents corresponding to process contents B with respect to the process contents “mulu d1, d3” on the third line, so processing advances to step ST402.

Step ST402: The compiler 5 determines whether or not a sufficient number of configuration cycles can be secured for configuring the FPGA 14 with circuit information necessary for executing the process contents “mulu d1, d3” on the third line. Here, the circuit information that is the object of judgment is circuit information 2. With respect to the process contents “mulu d1, d3” on the third line, the compiler 5 calculates the number of cycles CC necessary for the processor 12 to execute from the process contents “mov 0x00, d1” on the first line to the process contents “mov d2, d3” on the second line. When the number of cycles is 150 cycles, the number of configuration cycles FC is 120 cycles, so the compiler 5 determines that the condition FC≦CC is approved (a sufficient number of configuration cycles can be secured), and advances to step ST408.

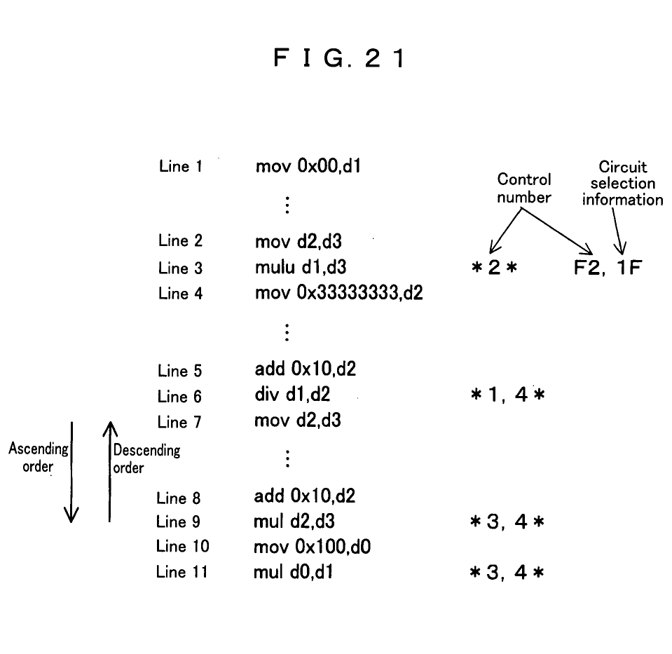

Step ST408: The compiler 5 decides that the process contents “mulu d1, d3” on the third line is the process contents that can be executed by the FPGA 14 using circuit information 2. The compiler 5 newly adds a control number “2”, and “1” that indicates circuit selection information that is necessary for executing the process contents “mulu d1, d3” with circuit information 2, to the process contents “mulu d1, d3” on the third line as information. FIG. 21 shows an example of the intermediate code at the time when execution of step ST408 has been completed. In the figure, “2” and “1” between Fs are the control number and circuit selection information that are added in step ST408.

Next, the processing of step ST40 is performed to the process contents “div d1, d2” on the sixth line.

Step ST401: The process contents “mulu d1, d3” on the third line are executed using circuit information 2. When the compiler 5 determines that the process contents “div d1, d2” cannot be executed using circuit information 2, advances to step ST402.

Step ST402: The compiler 5 determines whether or not a sufficient number of configuration cycles can be secured for configuring the FPGA 14 with the circuit information necessary for executing the process contents “div d1, d2” on. the sixth line. The circuit information that is the object of judgment is circuit information 1 having the minimum number of configuration cycles. With respect to the process contents “div d1, d2” on the sixth line, the compiler 5 calculates the number of cycles CC that are necessary for the processor 12 to execute from the process contents “mov 0x33333333, d2” on the fourth line to the process contents “add 0x10, d2” on the fifth line. When the number of cycles CC is 80 cycles, FC is 100 cycles, so the compiler determines that the condition FC≦CC is not approved (a sufficient number of configuration cycles cannot be secured), and advances to step ST403.

Step ST403: The compiler 5 determines whether or not a lock flag (information that indicates whether or not it is rejected to change the circuit information that is used for executing the process contents) is added to the process contents “mulu d1, d3” on the third line. In this case, lock flag is not added, so the compiler 5 advances to step ST404.

Step ST404: With respect to the process contents “div d1, d2” on the sixth line, the compiler 5 determines whether or not there is circuit information by which the process contents “mulu d1, d3” on the third line can be executed together. More specifically, the compiler 5 compares the values (“1” and “4”) between the asterisks “*” in the process contents “div d1, d2” on the sixth line, and the value (“2”) between the asterisks “*” in the process contents “mulu d1, d3” on the third line, and determines whether or not there are matching control numbers between them. In this case, there are no matching control numbers, so processing advances to step ST405.

Step ST405: With respect to the process contents “div d1, d2” on the sixth line, the compiler 5 determines whether or not first mode processing #1 accompanying execution by the processor 12 is faster than second mode processing #2 accompanying stopping operation of the processor 12, configuration to the FPGA 14 and execution by the processor 12. As in the case of step ST402, the circuit information that is the object of judgment is circuit information 1. With respect to the process contents “div d1, d2” on the sixth line, FC is 100 cycles, FD is 5 cycles, CC is 80 cycles and CD is 40 cycles, therefore, the condition FC+FD<CC+CD is approved (second mode processing 2 is faster than first mode processing 1), so processing advances to step ST408.

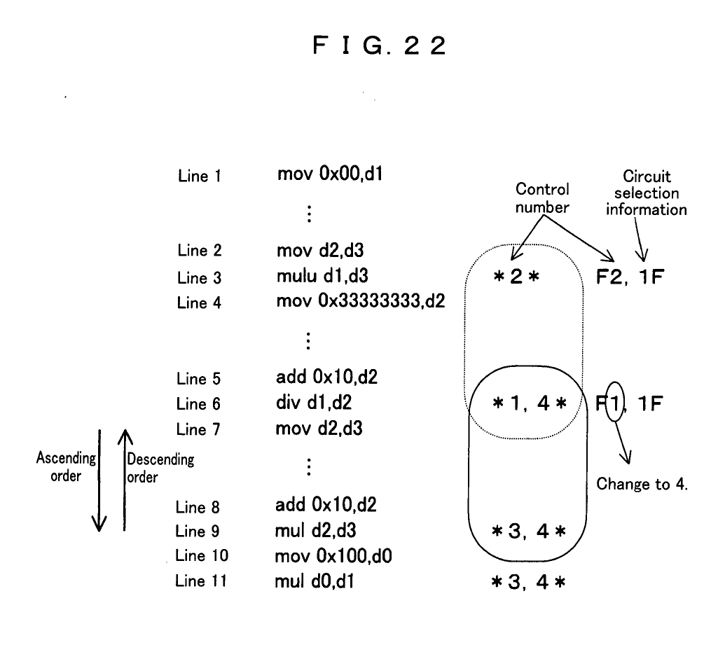

Step ST408: The compiler 5 decides that the process contents “div d1, d2” on the sixth line are executed by the FPGA 14 using circuit information 1. The compiler 5 newly adds control number “1”, and “1” that indicates the circuit selection information that is necessary for executing the process contents “div d1, d2” using control information 1, to the process contents “div d1, d2” on the sixth line as information. FIG. 22 shows an example of the intermediate code at the time when execution of step ST408 has been completed. In the figure, “1” and “1” that are framed in by the Fs are the control number and circuit selection information that are added in step ST408.

Next, the processing of step ST40 is performed to the process contents “mul d2, d3” on the ninth line.

Step ST401: The process contents “div d1, d2” on the sixth line are executed using circuit information 1. When the compiler 5 determines that the process contents “mul d2, d3” cannot be executed using circuit information 1, advances to step ST402.

Step ST402: The compiler 5 determines whether or not a sufficient number of configuration cycles can be secured for configuring the FPGA 14 with the circuit information necessary for executing the process contents “mul d2, d3” on the ninth line. The circuit information that is the object of the judgment is circuit information 3, which has the smallest number of configuration cycles. With respect to the process contents “mul d2, d3” on the ninth line, the compiler 5 calculates the number of cycles CC that are necessary for the processor 12 to execute from the process contents “mov d2, d3” on the seventh line to the process contents “add 0x10, d2” on the eighth line. When the number of cycles CC is 30 cycles, the number of configuration cycles FC is 105 cycles, so the compiler 5 determines that the condition FC≦CC is not approved (a sufficient number of configuration cycles cannot be secured), then advances to step ST403.

Step ST403: Since o lock flag is not added to the process contents “div d1, d2” on the sixth line, processing advances to step ST404.

Step ST404: The compiler 5 determines whether or not there is circuit information that can execute the process contents “div d1, d2” on the sixth line and the process contents “mul d2, d3” on the ninth line. More specifically, the compiler 5 compares the values between the asterisks “*” in the process contents “div d1, d2” on the sixth line with the values between the asterisks “*” in the process contents “mul d2, d3” on the ninth line. In this case, the compiler 5 determines that the control number 4 matches in both process contents, so advances to step ST410.

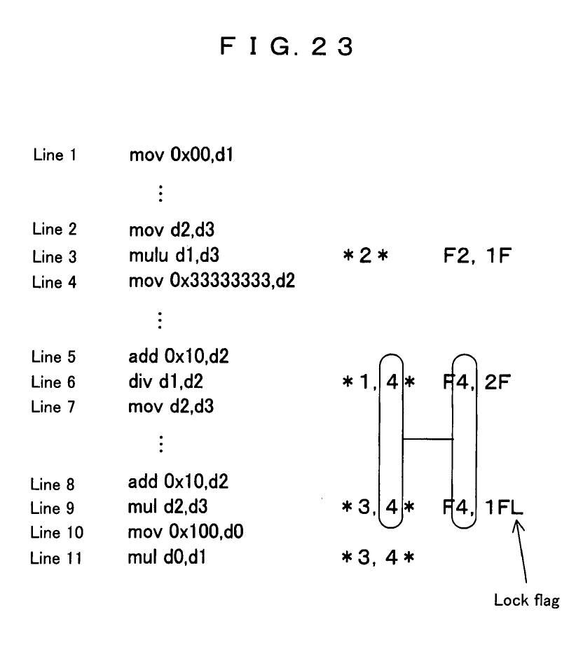

Step ST410: The compiler 5 decides to execute the process contents “div d1, d2” on the sixth line and the process contents “mul d2, d3” on the ninth line using circuit information 4. The compiler 5 newly adds control number “4” and the number “1” that indicates the circuit selection information necessary for executing “mul d2, d3” using circuit information 4, to the process contents “mul d2, d3” on the ninth line as information (the circuit selection information that corresponds to “mul A, B” on the fourth line of FIG. 17 is “1”). Also, the compiler adds a lock flag (information that indicates to reject change of the circuit information used for executing the process contents) to the process contents “mul d2, d3” on the ninth line. Also, with respect to the process contents “div d1, d2” on the sixth line, the compiler 5 replaces control number “1” between the “Fs” with control number “4”, and replaces circuit selection information “1” with circuit selection information “2” that is necessary for executing the process contents “div d1, d2” using circuit information 4. FIG. 23 shows an example of the intermediate code at the time when execution of step ST410 is finished. In the figure, “L” indicates a lock flag.

Finally, the processing of step ST40 is performed to the process contents “mul d0, d1” on the eleventh line.

Step ST401: The process contents “mul d2, d3” on the ninth line are executed using circuit information 4, and the compiler 5 determines that the process contents “mul d0, d1” can be executed using circuit information 4, so advances to step ST406.

Step ST406: The compiler 5 determines whether or not a lock flag is added to the intermediate code of the process contents “mul d2, d3” on the ninth line. In this case, a lock flag has been added, so processing advances to step ST409.

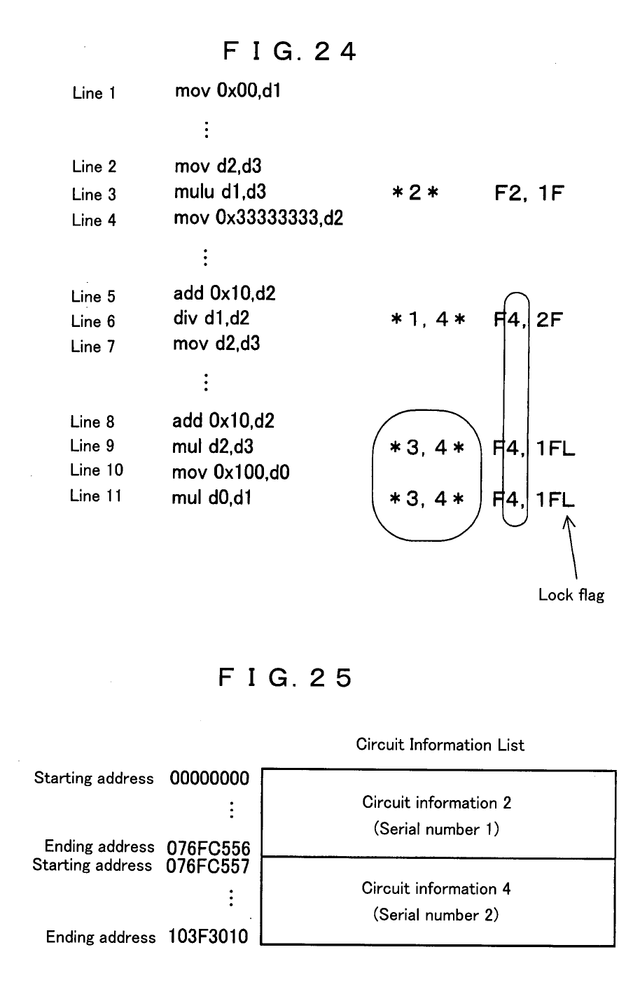

Step ST409: The compiler 5 decides to execute the process contents “mul d0, d1” on the eleventh line by the FPGA 14 using circuit information 4. The compiler 5 newly adds control number “4”, and the number “1” indicating the circuit selection information necessary for executing the process contents “mul d0, d1” with circuit information 4, to the process contents “mul d0, d1” on the eleventh line as information. Also, the compiler 5 adds a lock flag to the process contents “mul d0, d1” on the eleventh line. FIG. 24 shows an example of the intermediate code at the time when step ST409 is finished.

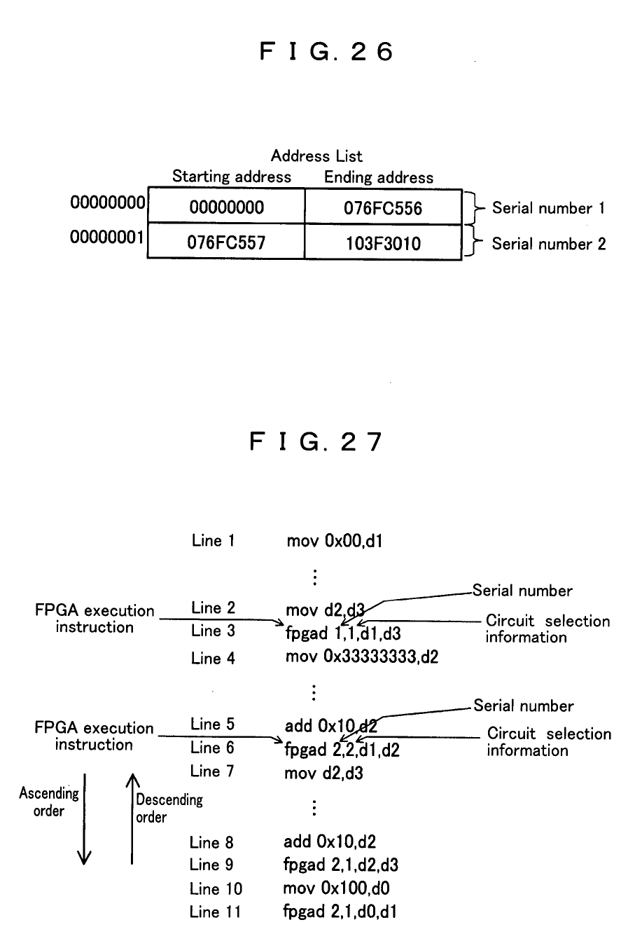

Step ST50: The compiler 5 creates a circuit information list F2 and an address list F3, which are obtained by extracting circuit information 2, 4 that is necessary for executing the process contents “mulu d1, d3”, “div d1, d2”, “mul d2, d3” and “mul d0, d1” that were determined to be executed by the FPGA 14 in step ST40. FIG. 25 shows an example of a circuit information list F2 in which circuit information 2, 4 have been extracted from the circuit information library 6. The values on the left side of FIG. 25 indicate the addresses where circuit information 2 and 4 are stored. In this step, the compiler 5 creates an address list F3 that indicates the addresses where the respective extracted circuit information are stored. FIG. 26 shows an example of the address list F3 that indicates the starting addresses and ending addresses where the circuit information 2 and 4 are stored. The values on the left side of FIG. 26 indicate the addresses where the starting addresses and ending addresses are stored. The compiler 5 may create the circuit information list F2 and address list F3 in response to the specifications of the circuit information holding and configuration controller 13. The compiler 5 assigns serial numbers 1, 2 to the control numbers 2, 4 of the circuit information 2, 4 when extracting the circuit information. By doing this, the serial numbers can be stored so that control number 2 corresponds to serial number 1, and control number 4 corresponds to serial number 2 respectively.

Step ST60: The compiler 5 replaces the process contents “mulu d1, d3” on the third line, the process contents “div d1, d2” on the sixth line, the process contents “mul d2, d3” on the ninth line and the process contents “mul d0, d1” on the eleventh line that were decided in steps ST408, ST409 and ST4310 to be executed by the FPGA 14, with FPGA execution instructions. Each of the process contents are replaced with the serial numbers that correspond to the control numbers that are surrounded by “Fs”, and FPGA execution instructions that indicate circuit selection information that is surrounded by the “Fs” with respect to each of the process contents. After replacement is finished, the compiler deletes the control numbers, circuit selection information and lock flags that were added in step ST40. FIG. 27 shows an example of the intermediate code at the time when processing up through step ST60 has been executed. In the figure, “fpgad” is an example of a FPGA execution instruction. The number “1” indicated by “fpgad” is the serial number that corresponds to circuit information 2, and “1” that is indicated by the serial number indicates the circuit selection information for executing “mulu A, B” using circuit information that corresponds to serial number 1, and “d1, d3” indicate data registers that are necessary for executing the process contents. Similarly, “fpgad” on the sixth line, “fpgad” on the ninth line and “fpgad” on the eleventh line are FPGA configuration instructions and FPGA execution instruction for the circuit information 4 that corresponds to serial number “2”, and the FPGA execution instruction on the sixth line indicates circuit selection information “2” for executing “div A, B”, and the FPGA execution instructions on the ninth and eleventh lines indicate circuit selection information “1” for executing “mul A, B”.

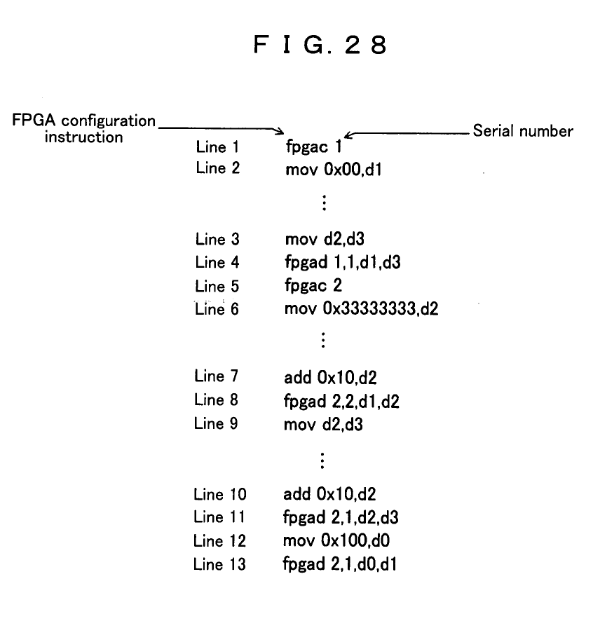

Step ST70: With respect to “fpgad 1, 1, d1, d3” on the third line of the intermediate code, “fpgad 2, 2, d1, d2” on the sixth line, “fpgad 2, 1, d2, d3” on the ninth line and “fpgad 2, 1, d0, d1” on the eleventh line, the compiler 5 determines the placement addresses for starting configuration of the FPGA 14 with the circuit information necessary for executing each of the process contents. The number after “fpgad” indicates the serial number, and the number following that number indicates the circuit selection information. In the case of “fpgad 2, 1, d1, d3” on the third line, there is no FPGA execution instruction in the descending order from the placement address of “fpgad 2, 1, d1, d3” on the third line, so the compiler 5 incorporates a FPGA configuration instruction (“fpgac 1”) that indicates serial number 1 before “mov 0x00, d1” on the first line. In the case of “fpgad 2, 2, d1, d2′ on the sixth line a serial number, that is different from that for “fpgad 1, 1, d1, d3” on the third line, is followed, so the compiler 5 incorporates a FPGA configuration instruction (“fpgac 2”) where serial number 2 continues to the next placement address after “fpgad 1, 1, d1, d3” on the third line. The serial numbers for “fpgad 2, 1, d2, d3” on the ninth line and “fpgad 2, 1, d0, d1” on the eleventh line have the same serial number as “fpgad 2, 2, d1, d2” on the sixth line, so the compiler 5 does not incorporate a FPGA configuration instruction. FIG. 28 shows an example of the intermediate code at the time when processing has been executed up through step ST70. In the figure, “fpgac” is an example of a FPGA configuration instruction, and the number indicated by “fpgac” is the serial number. “fpgac 1” on the first line indicates the process contents for configuring the FPGA 14 with circuit information 2 that corresponds to serial number 1, and “fpgac 2” on the fifth line indicates the process contents for configuring the FPGA 14 with circuit information 4 that corresponds to serial number 2.

Step ST80: The compiler 5 creates an execution program F1 from the intermediate code that was converted in step ST70.

As the example described above, with respect to “mul d2, d3” on the ninth line, circuit information 3 cannot acquire the number of configuration cycles necessary for configuring the FPGA 14, however, by configuring the FPGA 14 beforehand with circuit information 4 that can execute the process contents “mul A, B” and “div A, B”, the FPGA 14 can also execute “mul d2, d3” on the ninth line, so it is possible to improve the processing speed of the execution program F1.

According to this embodiment, when process contents, which can be executed by the FPGA 14, are close together in the intermediate code that is created by the compiler 5, the compiler 5 creates an execution program F1 so as to configure the FPGA 14 beforehand with circuit information that can execute a plurality of process contents. By doing so, even process contents that cannot acquire the number of cycles for configuring circuit information can be executed by the FPGA 14, which improves the performance of the overall system.

It is assumed that the circuit information that was the object of judgment in steps ST402 and step ST405 of this embodiment, was circuit information having the minimum number of configuration cycles, however, circuit information having the minimum number of execution cycles can be the object of judgment, even though the number of configuration cycles is a little larger. When circuit information having the minimum number of execution cycles is the object of judgment, processing performance can be improved for an execution program F1 where the same FPGA execution instruction is often repeated. Also, in this embodiment, a system, that includes circuit information that can execute two process contents, has been explained, however, a system could also be constructed so as to include circuit information that can execute three or more process contents.

### Embodiment 3

In the first and second embodiments, problems occur when there are interrupts or sub routine branching during execution of the execution program. Those problems are described below.

In the first and second embodiments, in a state when the following processing occurs:
an interrupt or sub routine branching occurs during configuring the FPGA 14 with circuit information 1 that corresponds to serial number 1;
in the aforementioned interrupt or sub routine processing, the FPGA 14 is configured with circuit information 2 that corresponds to serial number 2; and furthermore, when the following processing occurs:
the processor 12 recovers from the interrupt process or sub routine process;
the FPGA execution instruction that uses circuit information 1 corresponding to serial number 1 is executed;

and since the FPGA 14 is configured with circuit information 2, the processor 12 sends an instruction once again to the circuit information holding and configuration controller 13 to configure the FPGA 14 with circuit information 1.

By doing this, the processor performs the following processing:
stops operation of the processor 12 until configuration of the FPGA 14 is completed; and
when configuration of the FPGA 14 is completed, makes the FPGA 14 execute the process contents.

As just described, in the first and second embodiments, the FPGA 14 must be configured after the FPGA execution instruction is executed, so loss in the number of cycles becomes large, and it may not be possible to sufficiently improve processing performance by the FPGA 14.

This third embodiment of the invention solves this kind of problem. The third embodiment differs from the first and second embodiments in that a stack area inherent in this embodiment is provided in the processor 12, and furthermore, a mechanism, that instructs the circuit information holding and configuration controller 13, is provided in the processor 12.

When an interrupt or sub routine branching occurs while the processor 12 is executing the execution program F1, the stack area inherent in this embodiment functions as data memory for storing serial numbers that are read from the serial number register 32 of the circuit information holding and configuration controller 13, as is the case with a PC (Program Counter) (hereafter referred to as simply PC). Also, when processing returns from an interrupt process or sub routine process, the mechanism that is peculiar to this embodiment instructs the circuit information holding and configuration controller 13 to configure the FPGA 14 with the circuit information that corresponds to the serial number that is stored in the stack area. It is not shown in the figures in FIG. 1 and FIG. 15, but this stack area can also be arranged in memory provided outside of the processor.

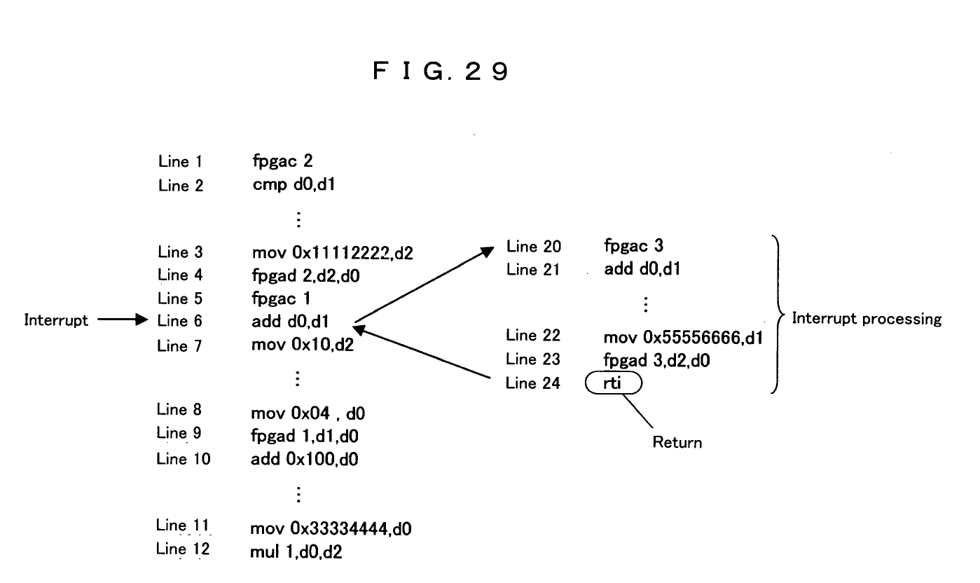

Using the example of intermediate code shown in FIG. 29, explained is processing in the case where an interrupt occurs while executing the execution program F1 in this third embodiment. FIG. 29 shows an example of intermediate code, where “rti” on line 24 is a process for returning from the interrupt process, and the other process contents are the same as those explained in FIG. 3, FIG. 5 and FIG. 13. Also, line numbers are shown on the left periphery of each line. The process contents on lines 20 to 24 indicate the interrupt process that is executed by the processor when an interrupt occurs, and after the processor 12 finishes the interrupt processing, processing returns to normal.

After reading the execution program F1 that is created through compiling the intermediate code shown in FIG. 29, the processor 12 executes the program in turn from the process contents “fpgac 2” on the first line of the intermediate code shown in FIG. 29. After executing the process contents “fpgac 1” on the fifth line, the processor 12 sends an instruction to the circuit information holding and configuration controller 13 to configure the FPGA 14 with circuit information that corresponds to serial number 1.

When an interrupt occurs while the processor 12 is executing the process contents “add d0, d1” on the sixth line, the processor 12 finishes executing the process contents “add d0, d1” on the sixth line, and then stores the PC and serial number, that was read from the serial number register 32, in the stack area of the processor 12 (in this example the serial number is 0). When the processor 12 completes storage to the stack area, processing branches to line 20 and the processor 12 begins executing the interrupt process. The processor executes the process contents “fpgac 3” on line 20, and sends an instruction to the circuit information holding/configuration controller 13 to configure the FPGA 14 with circuit information that corresponds to serial number 3. After the processor 12 makes the FPGA 14 execute the process contents “fpgad 3, d2, d0” on line 23, the processor 12 receives the execution result from the FPGA 14 and returns to the state of executing the process contents “move 0x10, d2” on line 7 after executing the process contents “rti” on line 24. Before the processor 12 executes the process contents “move 0x10, d2” on line 7, it sends an instruction to the circuit information holding and configuration controller 13 to configure the FPGA 14 with circuit information that corresponds to serial number 1 that is stored in the stack area. The processing at this time by the circuit information holding and configuration controller 13 is the same as that in the case where the processor has executed the FPGA configuration instruction. After sending an instruction to the circuit information holding and configuration controller 13 to configure the FPGA 14, the processor 12 executes the process contents “mov 0x10, d2” on and after line 7.

Here, in the interrupt processing shown in FIG. 29, when there are the FPGA configuration instruction and FPGA execution instruction that indicate serial number 2 instead of the FPGA configuration instruction and FPGA execution instruction that indicate serial number 3, or when there is no FPGA configuration instruction or FPGA execution instruction in the interrupt processing, the processor 12 attempts to configure the FPGA 14 with circuit information that corresponds to serial number 2 after returning from the interrupt processing. However, in this case, serial number 2 is stored in the serial number register 23 and the processor 12 determines that the circuit information holding and configuration controller 13 has already configured the FPFA 14 with circuit information corresponding to the serial number. Therefore, configuration is not performed after returning from the interrupt processing.

As described above, according to this embodiment, after returning from an interrupt processing or sub routine process, the processor 12 sends an instruction to configure the FPGA 14 with circuit information that corresponds to the serial number that is stored in the stack area. By doing so, it becomes possible to start configuration of circuit information that is necessary for executing a FPGA execution instruction before executing that FPGA execution instruction, which thus reduce loss in the number of cycles by that amount.

### Embodiment 4

In the first and second embodiments, a problem may occur when a branching occurs while executing the execution program F1 shown in FIG. 1. That problem is explained in detail below. When there is a branch to the program between the timing of executing the FPGA configuration instruction A in arbitrary circuit information A and the timing of executing the FPGA execution instruction A, the FPGA execution instruction may be executed without executing the FPGA configuration instruction. In such case, in the first embodiment, the FPGA status register 31 and serial number register 32 are read when executing the FPGA execution instruction A, and after confirming that the FPGA 14 is configured with circuit information A, the FPGA execution instruction A is executed. However, in the state of performing this kind of processing, it is thought that the circuit information A may not be configured. Herewith, a process of newly configuring the FPGA 14 with circuit information A occurs. During configuration, the processor 12 is in a waiting state, so the number of cycles during that time is wasted, which causes the overall performance of the system to drop. This embodiment corresponds to this problem as well, and has system configuration that takes branching into consideration. This embodiment is explained below.

This fourth embodiment differs from the first and second embodiments in the following points. In other words, a series of the following steps is set up:
The compiler shown in FIG. 1 searches for a branch instruction from the intermediate code.
When a branch instruction is found in the search for a branch instruction, the compiler 5 determines whether the operand of the detected branch instruction is a label or an immediate value.
When the operand of the branch instruction indicates a label or immediate value, the compiler 5 searches for an FPGA execution instruction based on ascending order of the placement address in the process contents in ascending order of the placement address of the branch destination indicated by that operand.
When a FPGA execution instruction is detected in the search for a FPGA execution instruction, the compiler 5 checks the serial number indicated by the FPGA execution instruction that is detected first, and incorporates the FPGA configuration instruction that indicates that serial number into the placement address of the intermediate code of the branch destination.

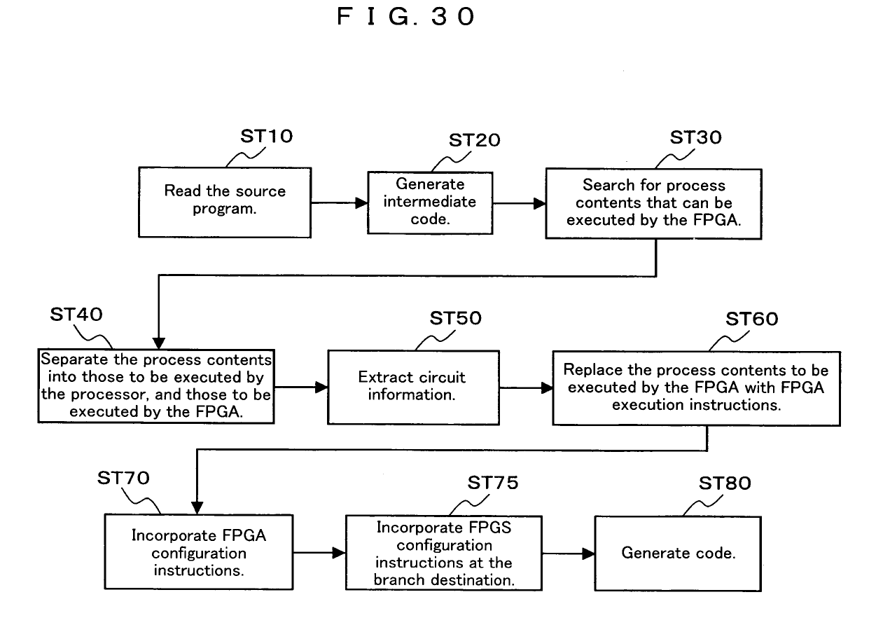

FIG. 30 shows the processing by the compiler in this embodiment. Step ST75 in FIG. 30 is the step in which the FPGA configuration instruction is incorporated into the placement address of the branch destination. Other than step ST75, the processing is the same as that shown in FIG. 6.

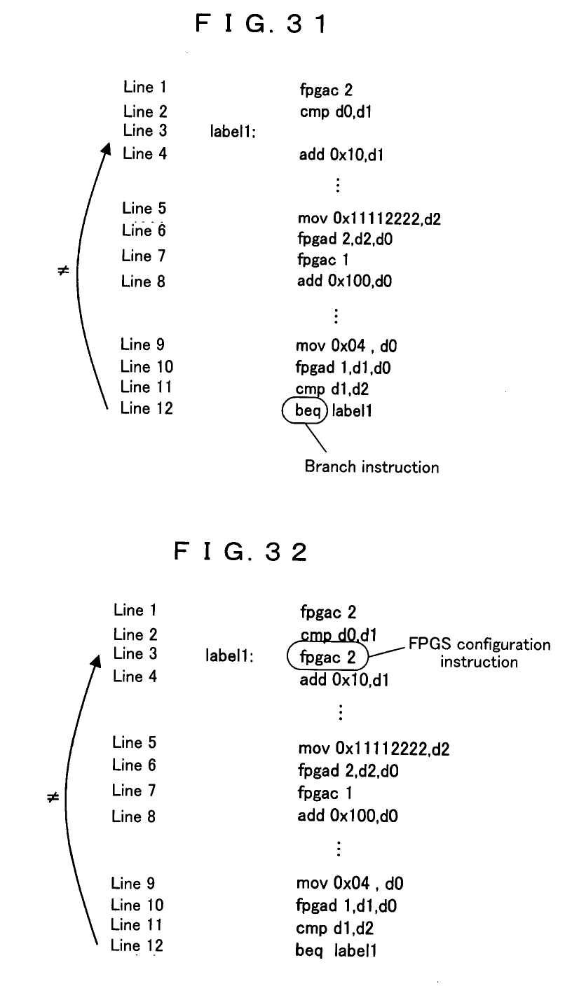

FIG. 31 shows an example of the intermediate code that is obtained after execution of the process up through step ST70 in FIG. 30. The process contents “beq” on line 12 is reflected on the operation results of the process contents “cmp d1, d2” on line 11, and when “d1” and “d2” are not equal, the next instruction is executed, and when “d1” and “d2” are equal, it is an instruction to branch to the address indicated by the operand of the process contents “beq”. In this example, since the operand of the process contents “beq” indicates “label 1” on line 3, the processor 12 branches to line 3 when “d1” and “d2” are equal.

In this embodiment, when the compiler 5 shown in FIG. 1 processed the example intermediate code shown in FIG. 31 in step ST75, the compiler 5 searches for a branch instruction from the example intermediate code shown in FIG. 31. In this example, the process contents “beq” on line 12 is a branch instruction, so the compiler 5 determines whether or not the operand of that instruction is a label or an immediate value. Here, when the compiler 5 determines that the operand of the process contents “beq” on line 12 is a label indicated as “label 1”, the compiler 5 searches for a FPGA execution instruction in ascending order of placement addresses with the process contents “label 1” as a base point. The compiler 5 checks the serial number of the process contents “fpgad 2, d2, d0” on line 6 that were found first, and incorporates the FPGA configuration instruction indicated by that serial number into line 3. The process contents “fpgad 2, d2, d0” on line 6 are executed using circuit information that corresponds to serial number 2, so the FPGA configuration instruction that is incorporated into line 3 is “fpgac 2”. Here, when there is a FPGA configuration instruction that corresponds to the FPGA execution instruction, or when there is no FPGA execution instruction, the compiler 5 does not incorporate a FPGA configuration instruction.

FIG. 32 shows an example of the intermediate code after the FPGA configuration instruction has been incorporated into the intermediate code example shown in FIG. 31. FIG. 32 differs from FIG. 31 in that the process contents “fpgac 2” have been incorporated into line 3. After compiling this intermediate code and creating an execution program, upon reading that execution program, the processor 12 executes it in ascending order of placement addresses starting from the process contents “fpgac 2” on line 1. The processor 12 outputs an instruction to the circuit information holding/configuration controller 13 so as to configure the FPGA 4 with circuit information that corresponds to serial number 2. The circuit information holding and configuration controller 13 compares the serial number 2 instructed by the processor 12 with the value in the serial number register 32. In this example, both values are different from each other, so the circuit information holding and configuration controller 13 configures the FPGA 14 with circuit information that corresponds to serial number 2. After performing the process described above, the processor 12 executes instructions sequentially, and executes the process contents “fpgac 2”, on line 3. The processor 12 sends an instruction to the circuit information holding and configuration controller 13 to configure the FPGA 14 with circuit information that corresponds to serial number 2. The circuit information holding and configuration controller 13 attempts to configure the FPGA 14 according to the instruction, however, it does not perform configuration because the value of the serial number register 32 is the same as serial number 2.

Next, when the processor 12 executes the process contents “fpgac 1” on line 7, the processor sends an instruction to the circuit information holding/configuration controller 13 so as to configure the FPGA 14 with circuit information that corresponds to serial number 1. The circuit information holding/configuration controller 13 configures the FPGA 14 according to the instruction. The processor 12 executes the process contents “fpgad 1, d1, d0” on line 10, and when a branch is generated in the process contents “beq label 1” on line 12, processing branches to the process contents on line 3. When branch is not generated, the processor executes the next instruction. When processing branches to line 3, the processor 12 executes the process contents “fpgac 2” and sends an instruction to the circuit information holding and configuration controller 13 so as to configure the FPGA 14 with circuit information that corresponds to serial number 2. The circuit information holding and configuration controller 13 configures the FPGA 14 according to the instruction. By doing this, it is possible to configure the FPGA 14 in advance before executing the FPGA execution instruction.

As was described above, according to this embodiment, even when a branch instruction is generated in the execution program, by incorporating a FPGA configuration instruction in that branch destination, it is possible to start configuration of the FPGA 14 with circuit information that is necessary for execution of the FPGA execution instruction before the processor 12 executes the FPGA execution instruction, which can reduce the number of cycles that gives the processor 12 a waiting period, and improve the overall performance of the system.

Though the preferred embodiments of the present invention were described in detail, the combination and arrangement of parts in those embodiments can be changed without affecting the spirit and scope of the claimed invention.

What is claimed is:

1. A semiconductor integrated circuit device comprising:
a processor;
an execution program holder that holds an execution program that includes execution instructions and configuration instructions that are executed by the processor;
a reconfigurable processing device that comprises a programmable device that can reconfigure a circuit, and that executes process contents that are instructed by the processor through executing the execution instructions; and
a circuit information holding and configuration controller that holds circuit information, and configures a circuit by incorporating the reconfigurable processing device with the circuit information that is designated when the processor executes the configuration instructions.

2. The semiconductor integrated circuit device of claim 1, wherein
the circuit information holding and configuration controller comprises:
a circuit information list holder that holds the circuit information;
an address list holder that holds address information for the circuit information; and
an incorporating and configuration unit that reads the address information, from the address list holder, that corresponds to the circuit information that is designated by the processor, uses the read address information to read circuit information from the circuit information list holder, and then incorporates the read circuit information into the reconfigurable processing device to configure a circuit.

3. The semiconductor integrated circuit device of claim 2, wherein
the circuit information holding and configuration controller further comprises a circuit ID information register that holds circuit ID information that identifies the circuit information that has been already incorporated in the reconfigurable processing device to configure a circuit; and
when the processor sends an instruction to incorporate the circuit information corresponding to the circuit ID information into the reconfigurable processing device so as to configure a circuit, the incorporating and configuration unit compares the circuit ID information concerning the instruction with the circuit ID information that is held in the circuit ID information register, and incorporates the circuit information into the reconfigurable processing device to configure a circuit, only when both do not match each other.

4. The semiconductor integrated circuit device of claim 2, wherein
in case of executing the execution instruction, the processor compares the circuit ID information indicated by the execution instruction with the circuit ID information held in the circuit ID information register, and when both match, instructs the reconfigurable processing device so as to execute the process contents indicated by the execution instruction, and when both do not match, instructs so as to incorporate the circuit information, that corresponds to the circuit ID information indicated by the execution instruction, into the reconfigurable processing device to configure a circuit, and then instructs the reconfigurable processing device to execute the process contents indicated by the execution instruction after the circuit information has been incorporated into the reconfigurable processing device to be configured.

5. The semiconductor integrated circuit device of claim 4, wherein
the circuit information holding and configuration controller further comprises
a status register that indicates whether or not the process for incorporating the circuit information corresponding to the circuit ID information held in the circuit ID information register into the reconfigurable processing device is finished; and wherein
in case of executing the execution instruction, the processor reads the value of the status register and determines whether or not the process for incorporating the circuit information corresponding to the circuit ID information held in the circuit ID information register into the reconfigurable processing device is finished, and the processor pauses the operation of sending an instruction for executing the process contents to the reconfigurable processing device, when the processor determines that the incorporating process is not finished, and sends an instruction for executing the process contents to the reconfigurable processing device, when the processor determines that the insertion process is finished.

6. A compiler device, comprising:
a circuit information library that stores a plurality of circuit information concerning each of the process contents incorporated into a reconfigurable processing device (FPGA, etc.) to be configured; and
a compiler that converts a source program to an execution program.

7. The compiler device of claim 6, wherein
the compiler has a function of separating the process contents into those to be executed by the processor and those to be executed by the reconfigurable processing device;
the compiler separates the process contents so that the number of process cycles of the overall execution program becomes small, in consideration of the number of execution cycles and the number of configuration cycles that are necessary for configuring the circuit information of the respective process contents in the execution program; and
the reconfigurable processing device comprises a programmable device that can reconfigure circuits, and execute the process contents that the processor instructs through implementing execution instructions.

8. The compiler device of claim 7, wherein
the compiler has
a function of replacing process contents, that were separated out as process contents to be executed by the reconfigurable processing device, with execution instructions; and
a function of incorporating configuration instructions, which indicate circuit ID information indicated by the execution instructions, into the execution program.

9. The compiler device of claim 8, wherein
the compiler has
a function of extracting circuit information from the circuit information library that is necessary for the reconfigurable processing device to execute the execution instructions, and creating a circuit information list that contains that circuit information; and
a function of creating an address list where addresses for storing the circuit information stored in the circuit information list are written down.

10. The semiconductor integrated circuit device of claim 2, wherein
the circuit information list holder comprises the circuit information capable of executing a plurality of the process contents.

11. The semiconductor integrated circuit device of claim 10 wherein
the reconfigurable processing device that is configured with the circuit information can execute a plurality of the process contents;
the execution instructions in the execution program holder include circuit selection information that designates any one of a plurality of the process contents of the circuit information; and
the processor has a function of instructing the reconfigurable processing device to execute the process contents indicated by the circuit selection information.

12. The compiler device of claim 9, wherein
the circuit information library comprises a plurality of the circuit information that can execute a plurality of the process contents.

13. The compiler device of claim 12, wherein
the compiler has a function that separates the process contents in the execution program into process contents to be executed by the processor and process contents to be executed by the reconfigurable processing device, in order to reduce the number of processing cycles of the overall execution program, in consideration of the number of execution cycles, the number of configuration cycles necessary for configuring the reconfigurable processing device with circuit information, and the process contents that can be executed by the circuit information.

14. The semiconductor integrated circuit device of claim 3, further comprising a data memory that stores data; and wherein
the processor has a function of storing circuit ID information that is stored in the circuit ID information register in the data memory when an interrupt is generated during execution of the execution program, and then, after return from the interruption process, reading the circuit ID information from the data memory and also instructing the circuit information holding and configuration controller to incorporate the reconfigurable processing device with circuit information, that corresponds to the read circuit ID information, to configure a circuit.

15. The compiler device of claim 8, wherein
the compiler comprises:
a first judgment unit that determines whether or not branch processing is contained in the execution program when the source program is compiled;
a second judgment unit that judges whether or not the branch destination of branch processing is determined upon receiving the judgment result from the first judgment unit;
a third judgment unit that determines whether or not there is an execution instruction in ascending order of placement address with the branch destination as a base point, upon receiving the judgment result of the second judgment unit; and
an incorporating unit that incorporates a configuration instruction constituting circuit information that is indicated by the execution instruction into the branch destination, upon receiving the judgment result of the third judgment unit.
